(19) United States
(12) Patent Application Publication
(10) Pub. No.: US 2021/0263533 A1
(43) Pub. Date: Aug. 26, 2021

(54) MOBILE OBJECT AND METHOD FOR CONTROLLING MOBILE OBJECT

(71) Applicant: SONY CORPORATION, TOKYO (JP)

(72) Inventors: TAKUTO MOTOYAMA, TOKYO (JP); TAKAAKI KATO, TOKYO (JP)

(21) Appl. No.: 17/250,204

(22) PCT Filed: Jun. 7, 2019
(86) PCT No.: PCT/JP2019/022683

§ 371 Date: Dec. 14, 2020

(30) Foreign Application Priority Data
Jun. 22, 2018 (JP) 2018-118470

(51) Int. Cl. G05D 1/02

(52) U.S. Cl. CPC G05D 1/0287; G05D 1/0088; G05D 1/0251

(57) ABSTRACT

The present technology relates to a mobile object and a method for controlling the mobile object that can improve the distance measurement accuracy. A cooperative sensing section obtains sensing information by performing sensing in cooperation with another mobile object. A control section controls movement according to a cooperative distance measurement using the sensing information. The cooperative distance measurement is a distance measurement performed in cooperation with the another mobile object. The present technology can be applied to a package delivery system.

### TECHNICAL FIELD

The present technology relates to a mobile object and a method for controlling the mobile object, and particularly, to a mobile object and a method for controlling the mobile object that can improve the distance measurement accuracy.

### BACKGROUND ART

Autonomous mobile robots and unmanned aerial vehicles that move outdoors use a passive sensor such as a stereo camera to measure the distance of the outside world, recognize 3D structures in the surrounding environment, and move autonomously.

In recent years, a stereo camera has been used for stereoscopic vision or distance measurement (see PTL 1).

### CITATION LIST

### Patent Literature

### [PTL 1]

Japanese Patent Laid-Open No. 2013-38454

### SUMMARY

### Technical Problem

There are small robots among autonomous mobile robots. In the case of small autonomous mobile robots, it is not possible to increase the baseline length, which is the inter-camera distance in a stereo camera, due to their design constraints or mechanical constraints. Accordingly, it is difficult to accurately perform a distance measurement for a long distance.

The present technology has been made in view of the situation above and can improve the distance measurement accuracy.

### Solution to Problem

A mobile object according to one aspect of the present technology includes a cooperative sensing section configured to obtain sensing information by performing sensing in cooperation with another mobile object, and a control section configured to control movement according to a cooperative distance measurement using the sensing information, the cooperative distance measurement being a distance measurement performed in cooperation with the another mobile object.

In one aspect of the present technology, sensing information is obtained by performing sensing in cooperation with another mobile object. Then, movement is controlled according to a cooperative distance measurement using the sensing information. The cooperative distance measurement is a distance measurement performed in cooperation with the another mobile object.

### Advantageous Effect of Invention

According to the present technology, the distance measurement accuracy can be improved.

It is noted that the effect described herein is not necessarily limited and any of the effects described in the present disclosure may be provided.

### BRIEF DESCRIPTION OF DRAWINGS

FIG. 1 is a diagram illustrating an example of a robot including a stereo camera.

FIG. 2 is a diagram illustrating a relationship between the distance and a distance measurement error.

FIG. 3 is a diagram illustrating an example of a robot control system to which the present technology is applied.

FIG. 4 is a diagram illustrating an example of a case where the space between robots is narrow.

FIG. 5 is a diagram illustrating an example of a case where the space between the robots is wide.

FIG. 6 is a block diagram illustrating an example of a configuration of the robot control system.

FIG. 7 is a diagram illustrating an example of a method of estimating relative positions between the robots.

FIG. 8 is a diagram illustrating an example of a method of obtaining the relative positions and attitudes between a marker and a front camera using an observation camera.

FIG. 9 is a diagram illustrating an example of estimation of a medium-to-long distance depth.

FIG. 10 depicts diagrams illustrating examples of a real space and an environment map.

FIG. 11 is a diagram illustrating examples of the occupancy probability of an obstacle in the vicinity of the distance of an estimated depth.

FIG. 12 is a diagram illustrating selective use of short distance sensing information and medium-to-long distance sensing information.

FIG. 13 is a diagram illustrating an example of relative position control for a case where there is an obstacle nearby.

FIG. 14 is a diagram illustrating an example of the relative position control for a case where there is an obstacle in the distance.

FIG. 15 is a diagram illustrating a relationship between the braking distance and the speed of the robot.

FIG. 16 is a flowchart describing control processing of a master robot.

FIG. 17 is a flowchart continuously describing the control processing of FIG. 16.

FIG. 18 is a flowchart describing control processing of a slave robot.

FIG. 19 is a diagram illustrating the timings of the control processing of the robots.

FIG. 20 is a diagram illustrating an example of a package delivery system to which the present technology is applied.

FIG. 21 is a diagram illustrating an example of a terrain observation system to which the present technology is applied.

FIG. 22 is a diagram illustrating an example of a cart delivery system to which the present technology is applied.

FIG. 23 is a diagram illustrating an example of a distance measurement assistance system to which the present technology is applied.

FIG. 24 is a diagram illustrating an example of a robot control system with three robots to which the present technology is applied.

FIG. 25 is a diagram illustrating an example of a robot control system with a plurality of robots to which the present technology is applied.

FIG. 26 is a block diagram illustrating an example of a hardware configuration of a computer.

### DESCRIPTION OF EMBODIMENTS

Modes for carrying out the present technology will be described below. The description will be given in the following order.

1. First Embodiment (Robot Control System)

2. Second Embodiment (High-Speed Package Delivery System)

3. Third Embodiment (Terrain Observation System)

4. Fourth Embodiment (Cart Delivery System)

5. Fifth Embodiment (Distance Measurement Assistance System)

6. Sixth Embodiment (Robot Control System with Three Robots)

7. Seventh Embodiment (Robot Control System with Plurality of Robots)

8. Computer

### 1. First Embodiment (Robot Control System)

<Overview>

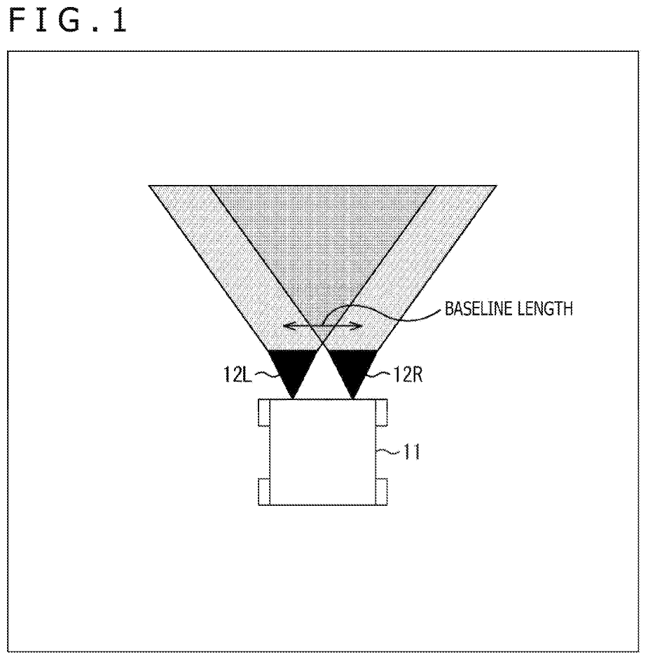

FIG. 1 is a diagram illustrating an example of a robot including a stereo camera.

A robot 11 includes a stereo camera including a front camera 12L and a front camera 12R. In FIG. 1, the front camera 12L and the front camera 12R are provided at the front of the body of the robot 11. Triangular regions extending upward in the figure from the front camera 12L and the front camera 12R represent their respective angles of view. The robot 11 performs a distance measurement using images photographed by the front camera 12L and the front camera 12R and moves autonomously on the basis of the result of the distance measurement.

In some cases, the baseline length between stereo cameras cannot be increased due to size, design, and structure constraints of the robot 11.

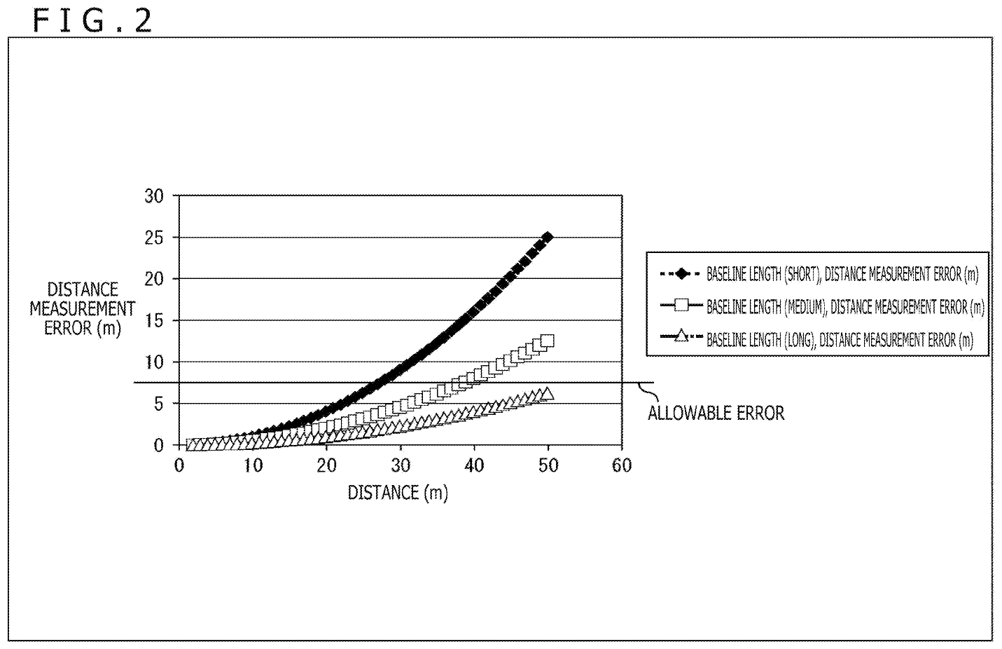

FIG. 2 is a diagram illustrating a relationship between the distance and a distance measurement error.

A dashed-dotted line with diamond marks represents distance measurement errors corresponding to distances up to 50 m in a stereo camera with a short baseline length. A dashed-dotted line with square marks represents distance measurement errors corresponding to distances up to 50 m in a stereo camera with a medium baseline length. A dashed-dotted line with triangle marks represents distance measurement errors corresponding to distances up to 50 m in a stereo camera with a long baseline length.

All of the distance measurement errors of the stereo camera with the long baseline length fall within an allowable error. However, the distance measurement errors of the stereo camera with the medium baseline length do not fall within the allowable error in long distances of approximately 40 to 50 m. The distance measurement errors of the stereo camera with the short baseline length do not fall within the allowable error in medium-to-long distances of approximately 30 to 50 m.

In this manner, in a case where the baseline length of a stereo camera is short, the accuracy of the distance measurement for a long distance is poor, limiting the range in which effective distance measurement can be performed.

Accordingly, in the present technology, sensing is performed in cooperation with a plurality of robots, and a cooperative distance measurement, which is a distance measurement performed in cooperation with the plurality of robots, is performed using sensing information obtained from the sensing. The movement of each robot is controlled according to the result of the cooperative distance measurement.

Here, “cooperation” refers to sharing information such as a synchronization signal, image information, distance information, and position information among the plurality of robots and acting on the basis of the shared information.

For example, “perform sensing in cooperation” and “cooperative sensing” refer to sharing a synchronization signal among the plurality of robots, obtaining image information and sensor information at the same timing on the basis of the shared synchronization signal, and calculating distance information using the obtained image and sensor information. The sensing information obtained by cooperative sensing includes image information, sensor information, distance information, and the like obtained from each of the robot itself and the other robot(s).

Further, “perform a distance measurement in cooperation” and “cooperative distance measurement” refer to a distance measurement performed on the basis of distance information, which is obtained by each of the plurality of robots, and cooperative distance information, which is obtained by sharing image information among the plurality of robots. It is noted that a distance measurement performed by a single robot will occasionally be referred to as a single distance measurement.

<Example of Robot Control System>

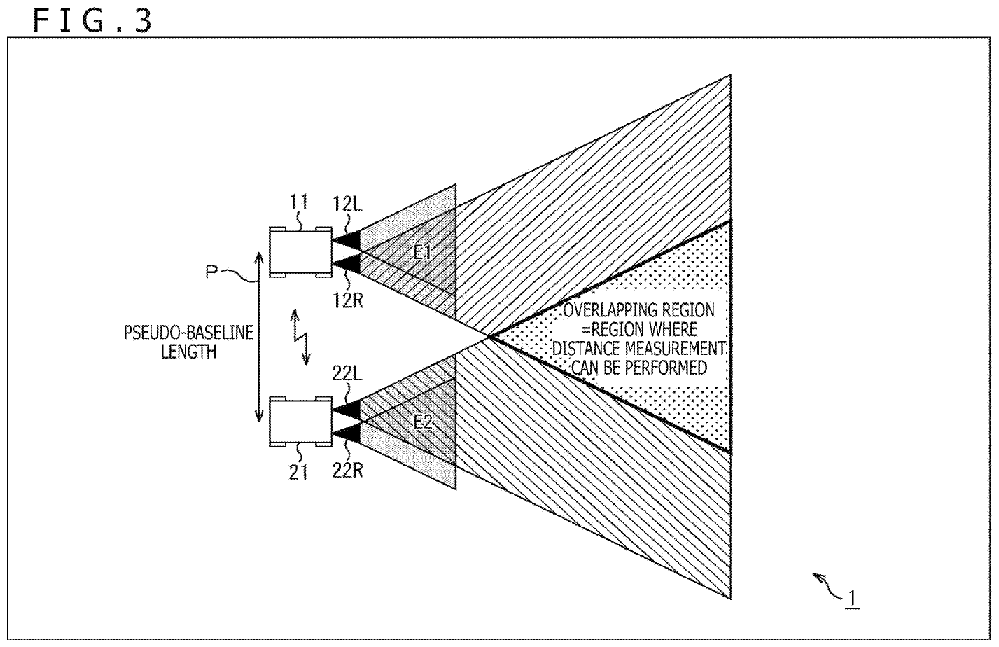

FIG. 3 is a diagram illustrating an example of a robot control system to which the present technology is applied.

As illustrated in FIG. 3, a robot control system 1 includes the robot 11 and a robot 21. The robot 11 and the robot 21 only need to be mobile objects. The robot 11 and the robot 21 include, other than robots, what is generally called drones that are aircrafts capable of unmanned flight, carts and vehicles that are mobile objects capable of moving autonomously, or the like.

The robot 11 includes the stereo camera including the front camera 12L and the front camera 12R. The front camera 12L and the front camera 12R face a direction in which a three-dimensional shape is to be recognized, for example, a direction of travel of the body. The robot 11 performs a single distance measurement targeting a short distance region E1 on the basis of an image obtained by the front camera 12L and an image obtained by the front camera 12R.

The robot 21 includes a stereo camera including a front camera 22L and a front camera 22R. The front camera 22L and the front camera 22R face a direction in which a three-dimensional shape is to be recognized, for example, a direction of travel of the body. The robot 21 performs a single distance measurement targeting a short distance region E2 on the basis of an image obtained by the front camera 22L and an image obtained by the front camera 22R.

In the robot control system 1, the distance between the center in the width direction of the robot 11 and the center in the width direction of the robot 21 is defined as a pseudo-baseline length P. The robot control system 1, for example, uses the front camera 12R of the robot 11 and the front camera 22L of the robot 21 as a stereo camera to perform a medium-to-long distance measurement, which is a distance measurement for a medium-to-long distance. In this case, an overlapping region between the angle of view of the front camera 12R and the angle of view of the front camera 22L is a region where the distance measurement can be performed.

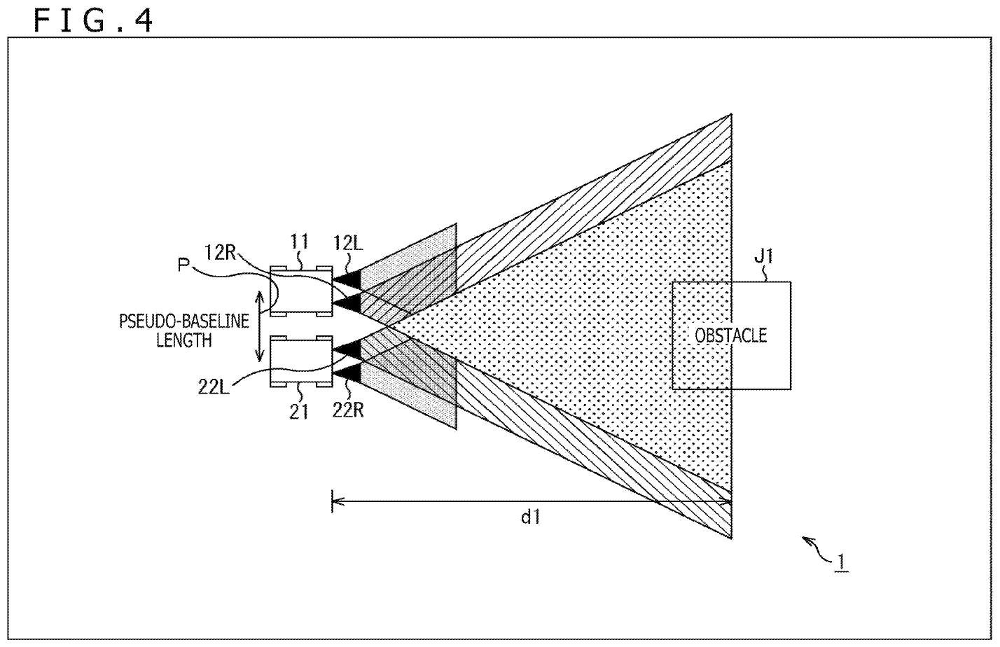

FIG. 4 is a diagram illustrating an example of a case where the space between the robots is narrow.

As illustrated in FIG. 4, in a case where the space between the robot 11 and the robot 21 is narrow, the pseudo-baseline length P is short. An obstacle J1 is included within the overlapping region between the angle of view of the front camera 12R and the angle of view of the front camera 22L. Since the obstacle J1 is within the overlapping region, the robot control system 1 can measure the distance to the obstacle J1. It is noted that the distance from the front camera 12R and the front camera 22L to the obstacle J1 is defined as a distance d1.

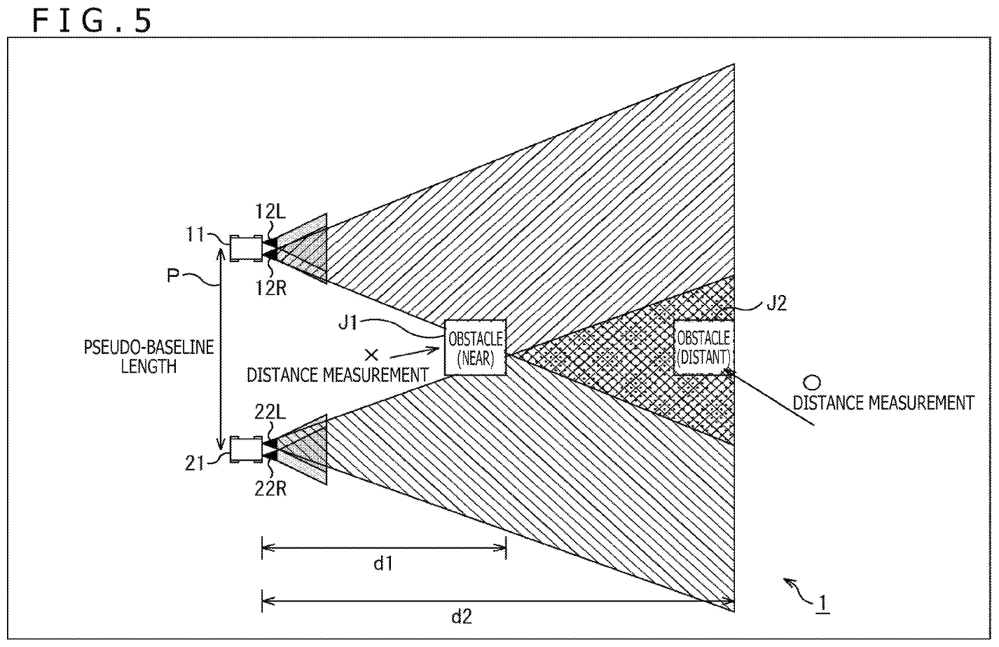

FIG. 5 is a diagram illustrating an example of a case where the space between the robots is wide.

As illustrated in FIG. 5, in a case where the space between the robot 11 and the robot 21 is wide, the pseudo-baseline length P is long. The obstacle J1, which is located at the distance d1, is not included within the overlapping region between the angle of view of the front camera 12R and the angle of view of the front camera 22L.

By contrast, an obstacle J2, which is located at a distance d2 (>d1), is included in the overlapping region between the angle of view of the front camera 12R and the angle of view of the front camera 22L.

In this case, the robot control system 1 cannot measure the distance to the obstacle J1, which is not within the overlapping region, but can measure the distance to the obstacle J2, which is within the overlapping region.

Hereinafter, in a case where it is not necessary to distinguish between the front camera 12L and the front camera 12R, which are included in the robot 11, the front camera 12L and the front camera 12R will be referred to as front cameras 12. Similarly, in a case where it is not necessary to distinguish between the front camera 22L and the front camera 22R, which are included in the robot 21, the front camera 22L and the front camera 22R will be referred to as front cameras 22.

<Example of Configuration of Robot Control System>

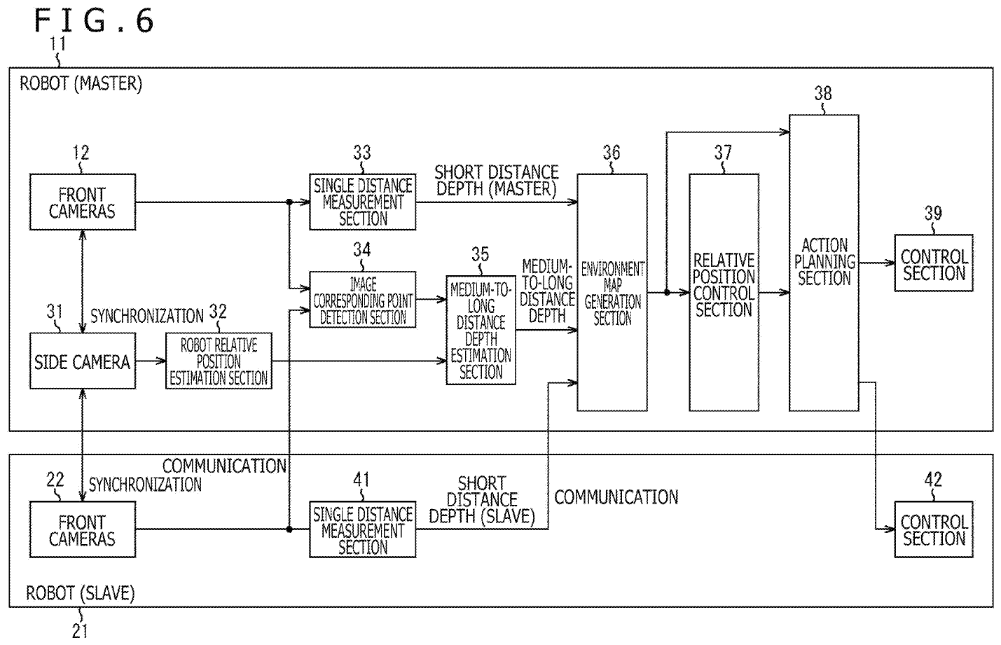

FIG. 6 is a block diagram illustrating an example of a configuration of the robot control system.

In the example of FIG. 6, the robot 11 is a master robot and the robot 21 is a slave robot. The robot 11 may be a slave robot and the robot 21 may be a master robot.

The robot 11 and the robot 21 are mutual cooperation partners. It is noted that although a communication section is omitted in FIG. 6, each of the robot 11 and the robot 21 includes a communication section. Signals between the robot 11 and the robot 21 are exchanged through wireless communication using the communication section.

The robot 11 includes the front cameras 12, a side camera 31, a robot relative position estimation section 32, a single distance measurement section 33, an image corresponding point detection section 34, a medium-to-long distance depth estimation section 35, an environment map generation section 36, a relative position control section 37, an action planning section 38, and a control section 39.

The robot 21 includes the front cameras 22, a single distance measurement section 41, and a control section 42.

In the robot control system 1 of FIG. 6, the cooperative sensing is performed by the front cameras 12, the front cameras 22, the side camera 31, the robot relative position estimation section 32, the single distance measurement section 33, the image corresponding point detection section 34, the medium-to-long distance depth estimation section 35, and the single distance measurement section 41.

The cooperative distance measurement is performed by the environment map generation section 36. In this case, a short distance depth, which is distance information obtained by the single distance measurement section 33, a short distance depth, which is distance information obtained by the single distance measurement section 41, and a medium-to-long distance depth, which is cooperative distance information obtained by the medium-to-long distance depth estimation section 35, are used. Sensing information obtained by performing the cooperative sensing includes the short distance depths and the medium-to-long distance depth.

The front cameras 12 capture respective images in synchronization with the side camera 31 and the front cameras 22. The images obtained by the image capturing are subjected to the removal of lens distortion, shading correction, and the like and then output to the single distance measurement section 33 and the image corresponding point detection section 34.

It is noted that the timing at which each of the front cameras 12, the front cameras 22, and the side camera 31 captures an image is synchronized by a synchronization signal. The robot 11 and the robot 21 perform time synchronization using a GPS PPS signal or the like, and the timing at which an image is captured is also synchronized with each other. Alternatively, the robot 11 and the robot 21 are synchronized with each other by using a trigger signal via the communication section not illustrated.

The side camera 31 is provided in the lateral direction of the body of the robot 11. The side camera 31 captures an image of the slave robot 21. The captured image is subjected to the removal of lens distortion, shading correction, and the like and then output to the robot relative position estimation section 32.

The robot relative position estimation section 32 estimates the relative positions and attitudes between the robots, that is, the robot 11 and the robot 21, by using the image supplied from the side camera 31. Information indicating the estimated relative positions and attitudes between the robots is output to the medium-to-long distance depth estimation section 35.

The single distance measurement section 33 includes a distance measurement sensor for a short distance. The distance measurement sensor is of a passive type and inexpensive. The single distance measurement section 33 estimates disparity by stereo matching using the images from the front cameras 12 and calculates a short distance depth (master) on the basis of the disparity. The single distance measurement section 33 outputs the obtained short distance depth to the environment map generation section 36.

From the two images captured by the two cameras whose relative positions are known, the image corresponding point detection section 34 detects corresponding points in the images by using block matching, feature matching, or the like. For example, as described with reference to FIG. 3, the image from the front camera 12R and the image from the front camera 22L are used for block matching or feature matching. The image corresponding point detection section 34 outputs the corresponding points in the images to the medium-to-long distance depth estimation section 35.

The medium-to-long distance depth estimation section 35 calculates a medium-to-long distance depth by general triangulation using the corresponding points in the images and the relative positions and attitudes between the front cameras 12, which are reference cameras. The medium-to-long distance depth indicates a three-dimensional distance to a target object. The medium-to-long distance depth estimation section 35 outputs the calculated medium-to-long distance depth to the environment map generation section 36.

The environment map generation section 36 performs a cooperative distance measurement using, as inputs, the short distance depths supplied from the single distance measurement section 33 and the single distance measurement section 41 and the medium-to-long distance depth obtained by the medium-to-long distance depth estimation section 35, and generates an environment map, which is the result of the cooperative distance measurement. The environment map is obtained by dividing a three-dimensional space by a Voxel Grid and estimating the Voxel occupancy probability in each Voxel on the basis of the sensing information including the distance information and the cooperative distance information. Each Voxel is a small volume cube with a certain scalar value/vector value. The environment map is output to the relative position control section 37 and the action planning section 38.

The relative position control section 37 controls the relative positions between the robots using information such as the speed and obstacle distribution, depending on the situation in the environment map. The relative position control section 37 outputs information regarding the relative positions between the robots to the action planning section 38.

The action planning section 38 plans actions for information regarding a point (a route, a latitude) on a route specified by the user and obstacle avoidance. That is, the action planning section 38 determines a route for avoiding an obstacle(s) existing on the route to the target point on the basis of the environment map and plans actions for the route such that the relative positional relationship between the robots becomes a target distance. The action planning section 38 outputs information indicating the determined action plan to the control section 39 and the control section 42.

The control section 39 controls a drive section, not illustrated, of the robot 11 on the basis of the action plan.

Meanwhile, the front cameras 22 of the slave robot 21 capture respective images in synchronization with the side camera 31 and the front cameras 12. The images obtained by the image capturing are subjected to the removal of lens distortion, shading correction, and the like and then output to the image corresponding point detection section 34 and the single distance measurement section 41.

The single distance measurement section 41 includes a distance measurement sensor for a short distance. The distance measurement sensor is of a passive type and inexpensive. The single distance measurement section 41 estimates disparity by stereo matching using the images from the front cameras 22 and calculates a short distance depth (master) on the basis of the disparity. The single distance measurement section 41 outputs the obtained short distance depth to the environment map generation section 36.

The control section 42 controls a drive section, not illustrated, of the robot 21 on the basis of the information indicating the action plan.

<Method of Estimating Relative Positions>

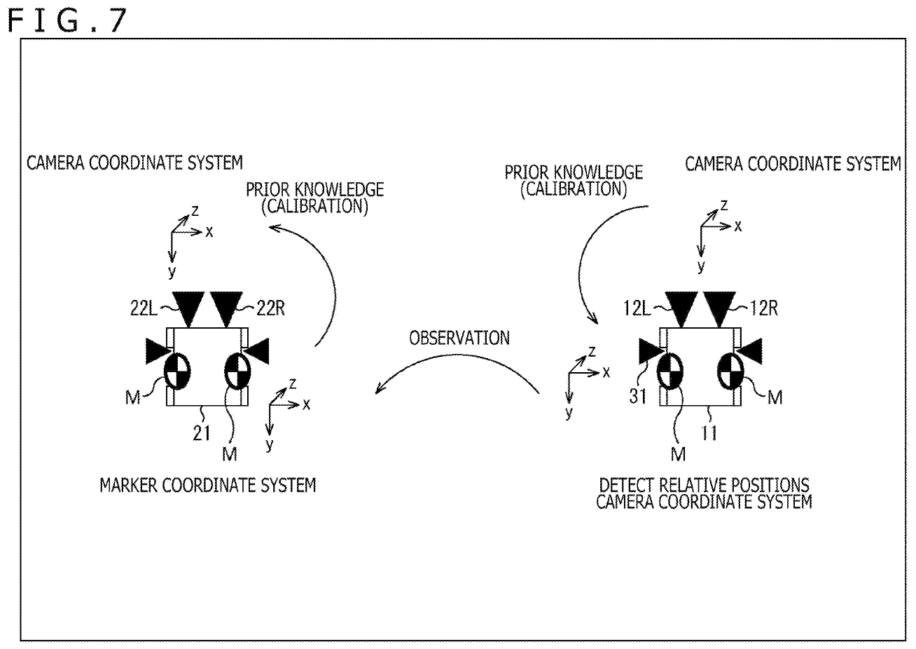

FIG. 7 is a diagram illustrating an example of a method of estimating relative positions between the robots.

As methods of obtaining the relative positions and attitudes between the robots, there are direct and indirect obtaining methods.

As the method of directly obtaining the relative positions and attitudes between the robots, the robot 11 detects a marker M on the body of the slave robot 21 using the side camera 31, as illustrated in FIG. 7.

In the example of FIG. 7, markers M are attached to the respective bodies of the robot 11 and the robot 21. Any marker M can be used as long as the size and the feature of the marker M are known and the distance to the marker M and its attitude can be obtained from an image in which the marker M is captured.

The robot 11 captures an image of the marker M of the slave robot 21 using the side camera 31, so that the robot 11 can obtain the position and attitude of the marker M (marker coordinate system) of the slave robot relative to the side camera 31 (relative position detection camera coordinate system).

In the robot 11, the relative positions and attitudes of the front camera 12 and the side camera 31 are known by prior calibration. Similarly, in the robot 21, the relative positions and attitudes of the front camera 22 and the marker M are known by prior calibration.

Accordingly, the robot relative position estimation section 32 can obtain an eventually required relative positional relationship, that is, the relative positions and attitudes between the front camera 12 of the master robot 11 and the front camera 22 of the slave robot 21.

It is noted that, moreover, as a method of obtaining the positions and attitudes between the marker M and the front camera on one body, there is a method of arranging an observation camera. The observation camera is a calibration camera that captures the marker M in its angle of view and includes a region overlapping with the angle of view of the front camera 12.

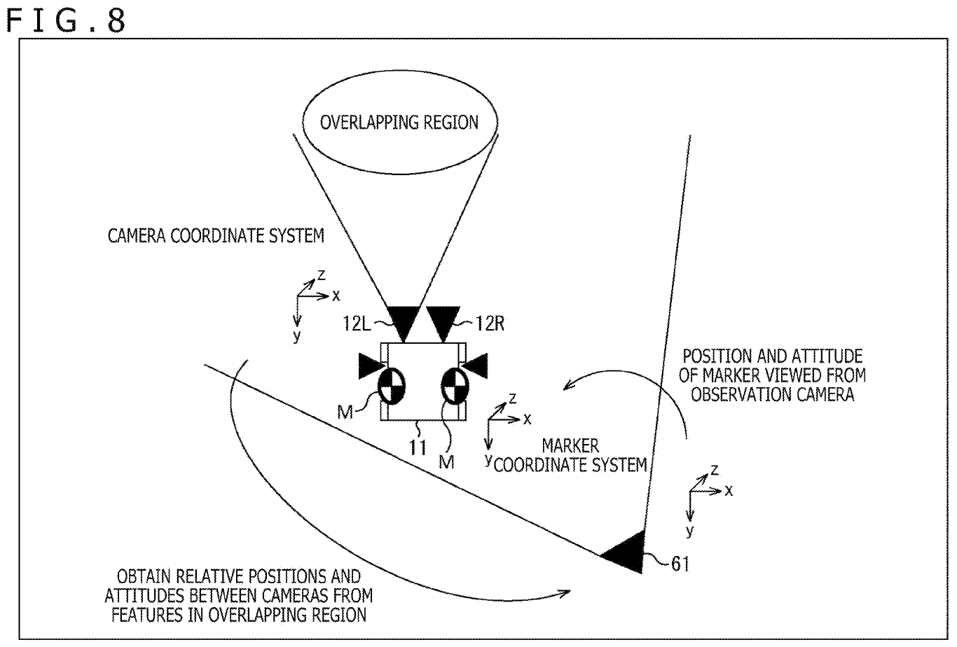

FIG. 8 is a diagram illustrating a method of obtaining the relative positions and attitudes between the marker and the front camera using the observation camera.

In FIG. 8, two lines extending from a triangle representing an observation camera 61 represent the angle of view of the observation camera 61. Further, two lines extending from a triangle representing the front camera 12L represent the angle of view of the front camera 12L.

The observation camera 61 is a camera placed outside of the body of the robot 11 to perform prior calibration. The positions and attitudes of the observation camera 61 and the marker M can be directly obtained because the marker M is captured in the angle of view of the observation camera 61, as illustrated in FIG. 8. Further, the observation camera 61 and the front camera 12 of the robot 11 have a region where their angles of view overlap with each other, as indicated by an ellipse. Therefore, the relative positions and attitudes of the two can be obtained by placing a known calibration chart in this region.

As a result, the relative positions and attitudes between the marker M and the front camera 12 can be obtained via the coordinate system of the observation camera 61. Information regarding the relative positions and attitudes between the marker M and the front camera 12 is stored as the result of the calibration. As long as the marker M and the front camera 12 are fixed to one body, the relative positions and attitudes between the marker M and the front camera 12 can be obtained by performing the prior calibration just once.

The above description is regarding the calibration of the position and attitude of the front camera 12. This also similarly applies to the calibration of the positions and attitudes of the side camera 31 and the front camera 12. Placing the observation camera 61 therebetween enables prior calculation using a general inter-camera calibration method.

In this manner, information indicating the positions and attitudes between the front cameras 12 obtained in advance is stored as calibration information. When an actual distance measurement is performed, the relative positions and attitudes between the front cameras needed to be obtained can be estimated by detecting the marker M of the slave robot 21 using the side camera 31 of the master robot 11.

Further, although the marker M is used as the method of directly estimating the relative positions and attitudes between the robots, it is also possible to estimate the position and attitude of the front camera by detecting the robot itself instead of the marker M, using the known shape of the robot.

Moreover, although the relative positions and attitudes are obtained by detecting the slave robot 21 using the side camera 31 in the method described above, there is also a method of obtaining the relative positions and attitudes by detecting the slave robot 21 without using the side camera 31. For example, it is also possible to estimate the relative positions and attitudes between the cameras from the positions of common features in the overlapping region between the cameras facing the same direction. Although this method advantageously requires a small number of cameras, this method also has a disadvantage that the conditions under which the relative positions are obtained are scene dependent.

Further, as the method of indirectly estimating the relative positions and attitudes between the cameras, there is a method of using Localization that identifies the position. Under this method, each robot obtains its own coordinates using GPS or performs Localization to a map in a case where the map is prepared in advance. Since this allows each robot to know where the robot itself is located in the world coordinate system, it is possible to estimate the relative positions and attitudes from the coordinates of each robot.

<Example of Estimation of Medium-to-Long Distance Depth>

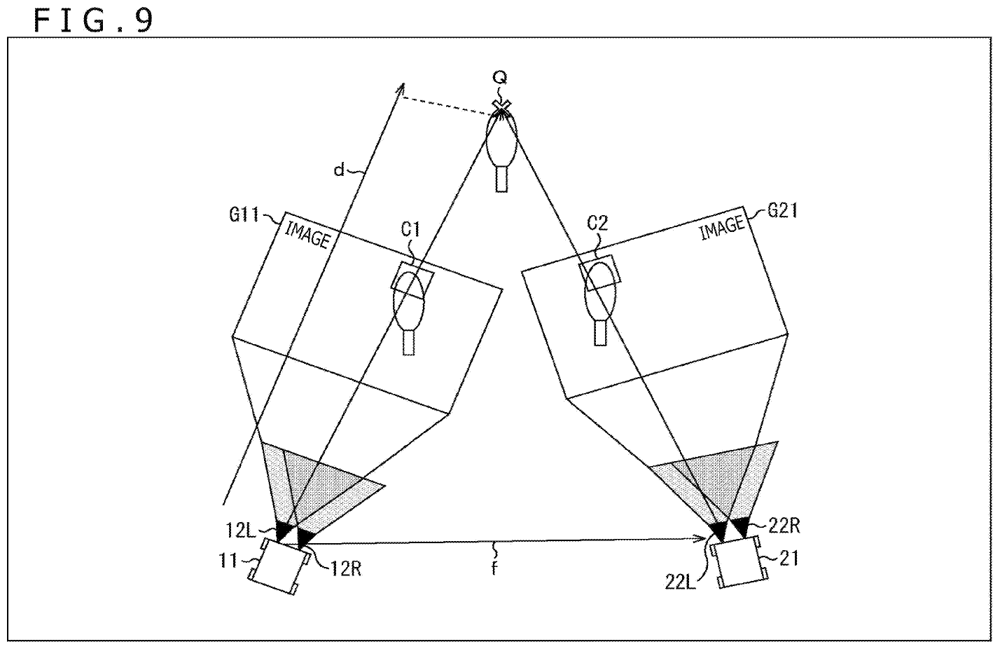

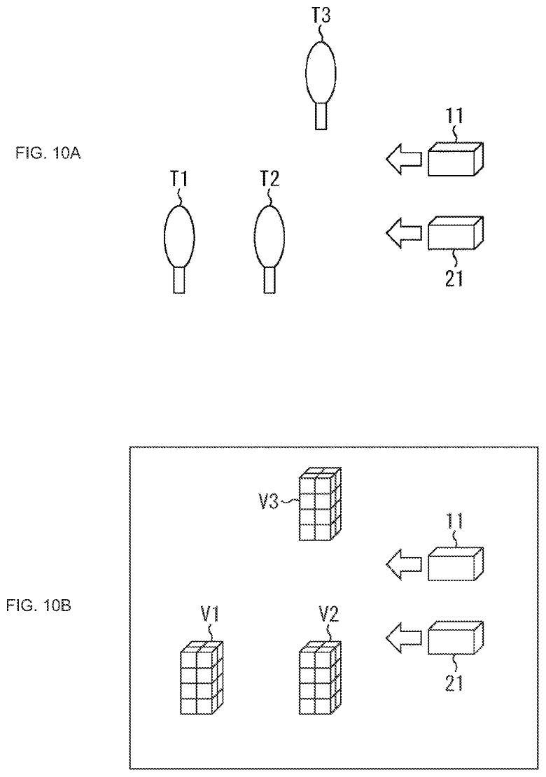

FIG. 9 is a diagram illustrating an example of estimation of a medium-to-long distance depth.

FIG. 9 illustrates a corresponding point C1, which is in an image G1 captured by the front camera 12L of the robot 11, and a corresponding point C2, which is in an image G21 captured by the front camera 22L of the robot 21. The corresponding points C1 and C2 are detected by the image corresponding point detection section 34.

An arrow f indicates that the relative positions and attitudes of the robot 11 and the robot 21 are known. The relative positions and attitudes of the robot 11 and the robot 21 are estimated by the robot relative position estimation section 32.

The corresponding point C1 in the image Eli, the corresponding point C2 in the image E21, and the relative positions and attitudes between the robots indicated by the arrow f have been obtained. Therefore, the medium-to-long distance depth estimation section 35 can estimate the three-dimensional distance to a target object Q by general triangulation.

<Method of Generating Environment Map>

The environment map generation section 36 generates an environment map using, as inputs, the short distance depths supplied from the single distance measurement section 33 and the single distance measurement section 41 and the medium-to-long distance depth obtained by the medium-to-long distance depth estimation section 35. The environment map is one of the results of cooperative distance measurement.

FIG. 10 depicts diagrams illustrating examples of a real space and an environment map.

A of FIG. 10 illustrates an example of the real space. B of FIG. 10 illustrates an example of the environment map generated on the basis of the real space.

As illustrated in A of FIG. 10, trees T1 to T3 exist in the direction in which the robot 11 and the robot 21 are heading. The robot 11 and the robot 21 obtain sensing information by performing sensing in cooperation.

On the basis of the obtained sensing information, a three-dimensional space is divided by a Voxel Grid and the Voxel occupancy probability in each Voxel is estimated. As a result, an environment map is generated as illustrated in B of FIG. 10. In the environment map, an obstacle V1 is placed at a position corresponding to the tree T1, an obstacle V2 is placed at a position corresponding to the tree T2, and an obstacle V3 is placed at a position corresponding to the tree T3.

In the environment map illustrated in B of FIG. 10, the obstacles V1 to V3 are denoted by block-shaped Voxels. All the Voxels in a certain three-dimensional space divided by a Voxel Grid include occupancy probability information. In a case where the occupancy probability is high, the Voxel has a high probability of being an obstacle. In a case where the occupancy probability is low, the Voxel is a free space. The environment map of B of FIG. 10 denotes a final result in which only portions larger than a certain value of the occupancy probability are displayed as block-shaped Voxels.

The environment map is generated by setting the associated Voxel occupancy probabilities to all the respective estimated depths and integrating each occupancy probability using Bayes' theorem or the like.

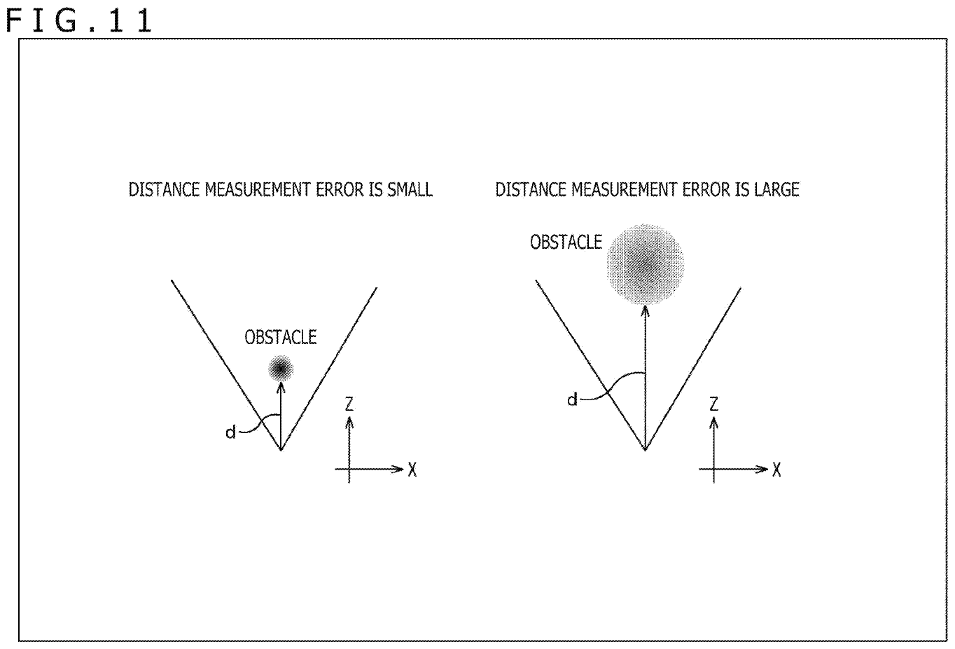

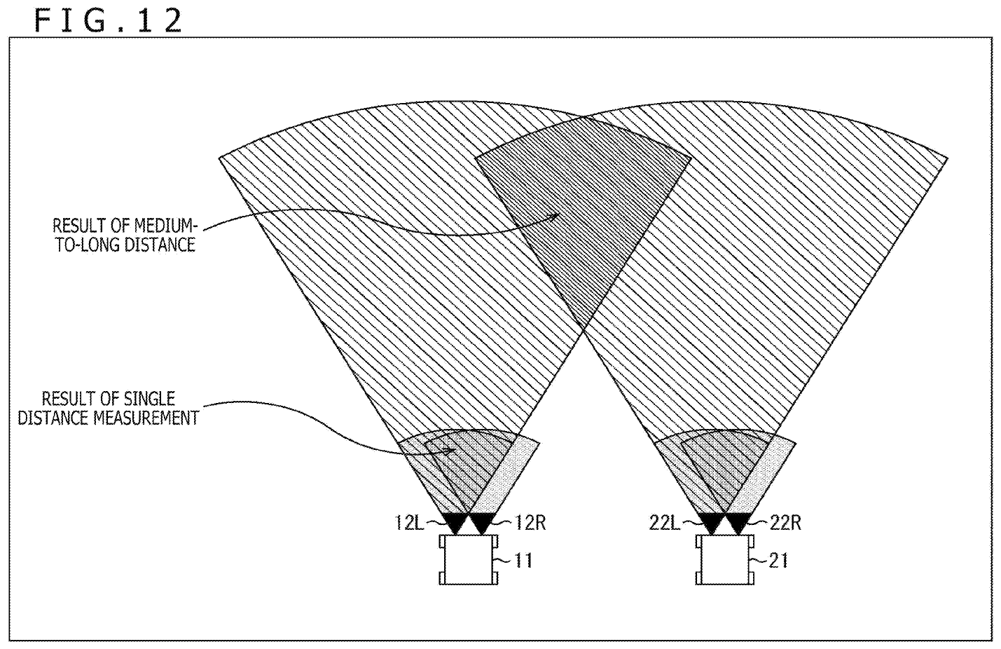

FIG. 11 is a diagram illustrating examples of the occupancy probability of an obstacle in the vicinity of the distance of an estimated depth.

In the Voxels corresponding to respective pixels of the estimated depth map in the line-of-sight direction, the occupancy probability of an obstacle in the vicinity of the distance of an estimated depth d is set to high. On the other hand, the occupancy probability of any Voxel in front of the estimated depth d is set to low.

Further, the situation of a region with a high occupancy probability in the vicinity of the distance of the estimated depth varies depending on the distance measurement error.

As illustrated on the left side of FIG. 11, in a case where the distance measurement error is small, the region with a high occupancy probability in the vicinity of the distance of the estimated depth is concentrated near one Voxel.

By contrast, as illustrated on the right side of FIG. 11, in a case where the distance measurement error is large, the region with a high occupancy probability in the vicinity of the distance of the estimated depth is spread.

In generating an environment map, it is desirable to use sensing information whose distance measurement error and spread are as small as possible. This distance measurement error is determined by the baseline length and the like described above with reference to FIG. 1 and the like. The more distant the distance measurement target is, the better it is to employ a camera arrangement with a long baseline length.

On the other hand, in a case where a short distance depth is to be obtained with a long baseline length, there are also disadvantages that a large search range is required at the time of image matching and an influence of a cut-off due to the angle of view increases.

Therefore, as illustrated in FIG. 12, to estimate the occupancy probability of a Voxel region at a short distance from the robot 11, it is desirable to use sensing information for a short distance obtained by a single distance measurement. On the other hand, to estimate the occupancy probability of a Voxel region in the distance, it is desirable to use sensing information obtained by a medium-to-long distance measurement.

As illustrated in FIG. 12, the result of the single distance measurement using images supplied from the front camera 12L and the front camera 12R of the robot 11 is used to estimate the occupancy probability of the Voxel region at a short distance from the robot 11. Similarly, as illustrated in FIG. 12, the result of the single distance measurement using images supplied from the front camera 22L and the front camera 22R of the robot 21 is used to estimate the occupancy probability of the Voxel region at a short distance from the robot 21.

By contrast, as illustrated in FIG. 12, the result of the medium-to-long distance measurement supplied from the front camera 12L of the robot 11 and the front camera 22L of the robot 21 is used to estimate the occupancy probability of the Voxel region at a medium-to-long distance from the robot 11.

In this manner, in the present technology, when an environment map is generated, the sensing information from the single distance measurement or the sensing information from the medium-to-long distance measurement is selectively used depending on the distance. Further, in the present technology, since the angle of sensing can be expressed as the occupancy probability, fusion (synthesis) using the occupancy probability may be simply performed.

Moreover, it is also possible to obtain an environment map with even higher accuracy by fusing (synthesizing) a Voxel map, which includes the occupancy probabilities obtained by the above-described processing, in the temporal direction using self-position information.

It is noted that in a case where the robot 11 is a robot that moves on the ground, a 2D Occupancy Grid Map may be used instead of a 3D Voxel.

<Examples of Relative Position Control>

Each robot is a mobile object. Thus, its relative position can be controlled dynamically depending on the situation. The following three methods can be used to control the relative positions.

(1) Control according to obstacle distribution

(2) Control according to speed

(3) Control according to altitude

<Control According to Obstacle Distribution>

To perform the control according to obstacle distribution, distribution with a coarse resolution using a millimeter-wave radar or an environment map accumulated until the past time can be used.

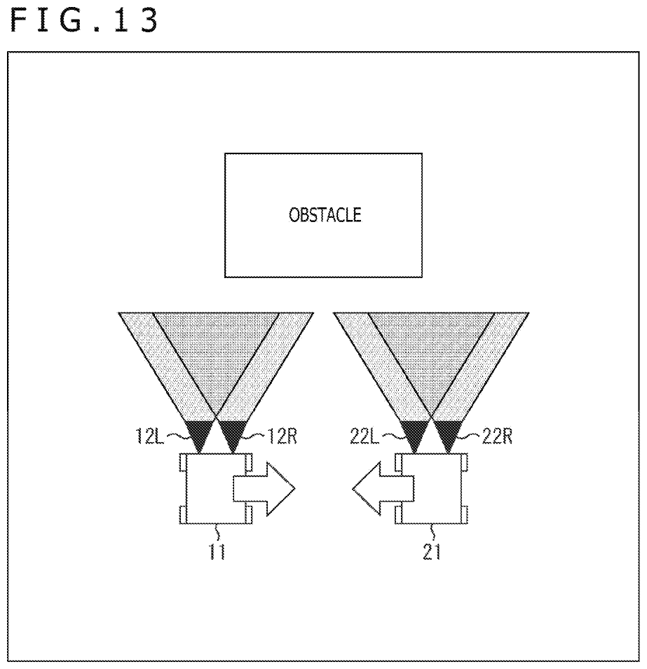

FIG. 13 is a diagram illustrating an example of the relative position control for a case where there is an obstacle nearby.

In FIG. 13, there is an obstacle in front of the robot 11 and the robot 21.

As indicated by white arrows of FIG. 13, in a case where there is an obstacle nearby, the control is performed such that the space between the robots becomes narrower in accordance with the distance to the nearest obstacle.

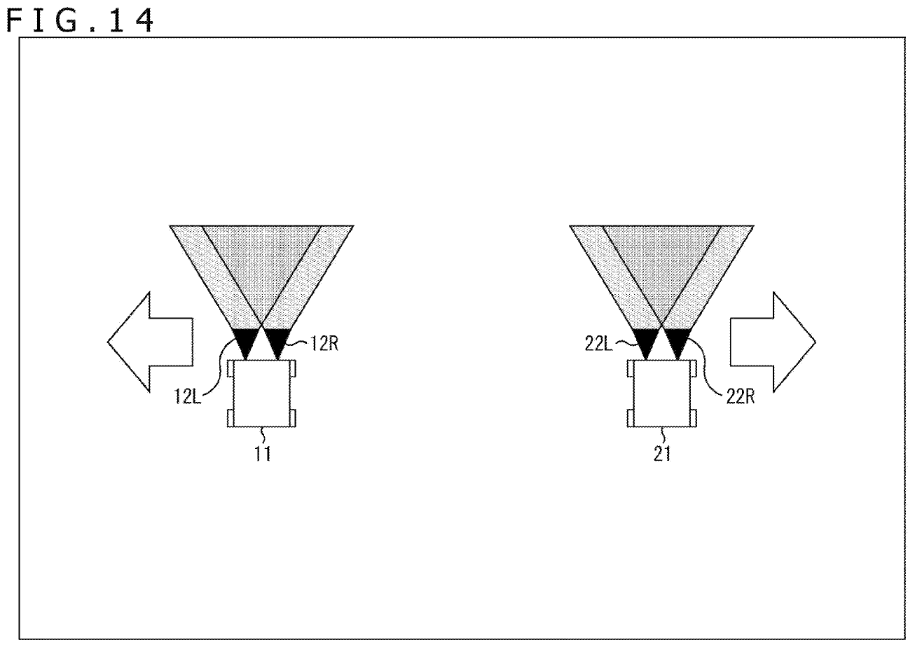

FIG. 14 is a diagram illustrating an example of the relative position control for a case where there is an obstacle in the distance.

In FIG. 14, there is an open space in front of the robot 11 and the robot 21. Therefore, the robots can move at high speed and the control is performed such that the robots are spaced farther apart to place a priority on a distant location, as indicated by white arrows of FIG. 14.

<Control According to Speed>

In the case of high-speed movement, the braking distance is long. Thus, the control can be performed such that the space between the robots becomes wide, placing a priority on the accuracy of a long distance measurement. In the case of low-speed movement, the braking distance is short. Thus, the control can be performed such that the space between the robots becomes narrow. With this control, it is possible to increase the accuracy of a short-to-medium distance measurement, allowing more detailed route planning.

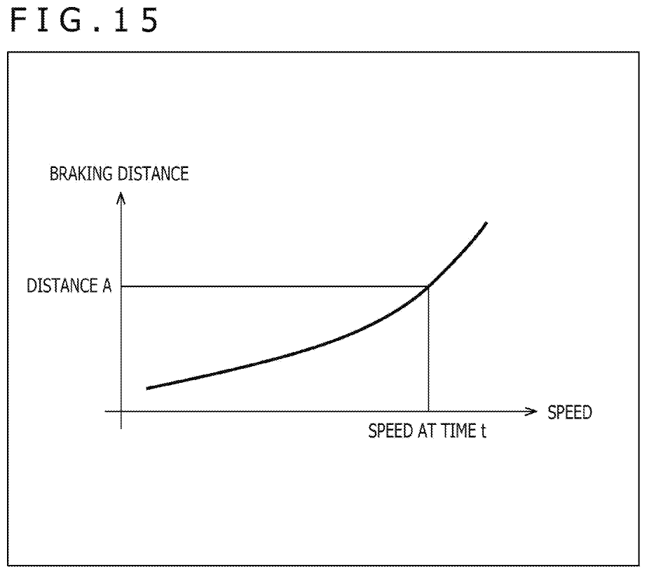

FIG. 15 is a diagram illustrating a relationship between the braking distance and the speed of the robot.

In the graph of FIG. 15, the horizontal axis represents the speed while the vertical axis represents the braking distance.

A pseudo-baseline length b for achieving a distance measurement error e with respect to a distance A (m) with the speed at time t is obtained by a stereo distance measurement error calculation formula represented in the following formula (1).

$$\begin{matrix}[ Math . 1 ] & \\ Δ Z = \frac{{Z}^{2}}{b \times f} Δ d & ( 1 )\end{matrix}$$

Here, Z is the distance to an object, f is the focal length of the camera, AZ is a distance measurement error, and Δd is a pixel position error at an image corresponding point.

The pseudo-baseline length b for achieving the distance measurement error e at the distance A(m) of the distance measurement target is obtained from the following formula (2), which is an expansion of the formula (1).

$$\begin{matrix}[ Math . 2 ] & \\ b = \frac{{A}^{2}}{e \times f} Δ d & ( 2 )\end{matrix}$$

<Control According to Altitude>

In a case where the relative position control is performed according to the altitude, GPS and a barometer are used as altitude information.

In a case of a high altitude, the distance to the ground is long. Therefore, it is possible to cope therewith by widening the space between the robots. On the other hand, in a case of a low altitude, the distance to the ground is short. Therefore, it is possible to cope therewith by narrowing the space between the robots.

It is noted that if the robots are spaced too far apart, the robots cannot communicate with each other or detect a marker used for relative position estimation. The maximum value of the space between the robots is determined in advance and the control is performed within a range that does not exceed the maximum value.

Further, this similarly applies to the minimum value of the space between the robots. The control is performed such that the space between the robots does not fall below the minimum value.

<Examples of Operations>

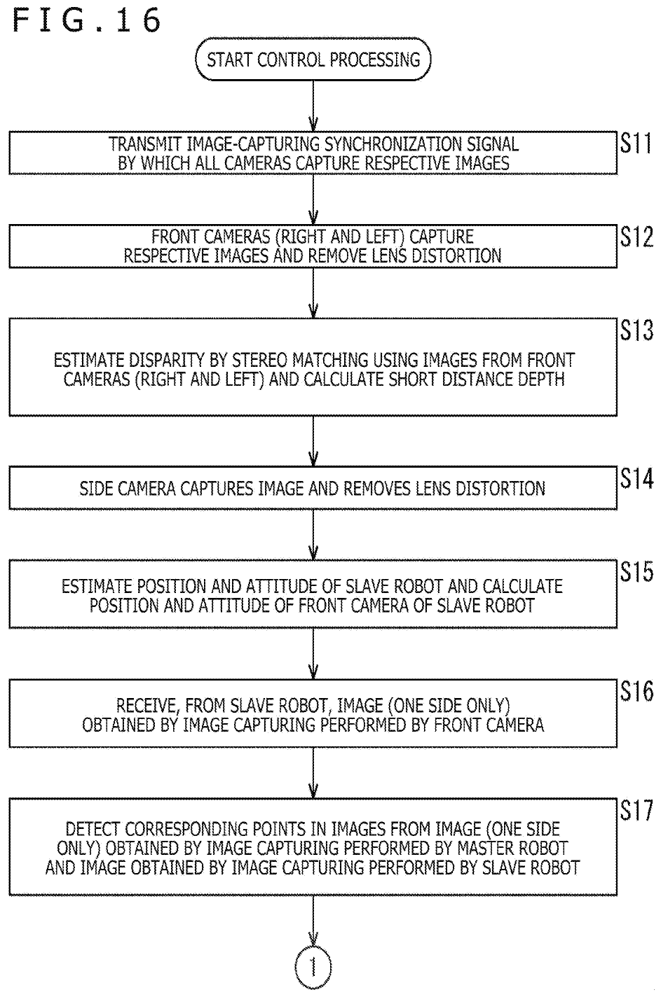

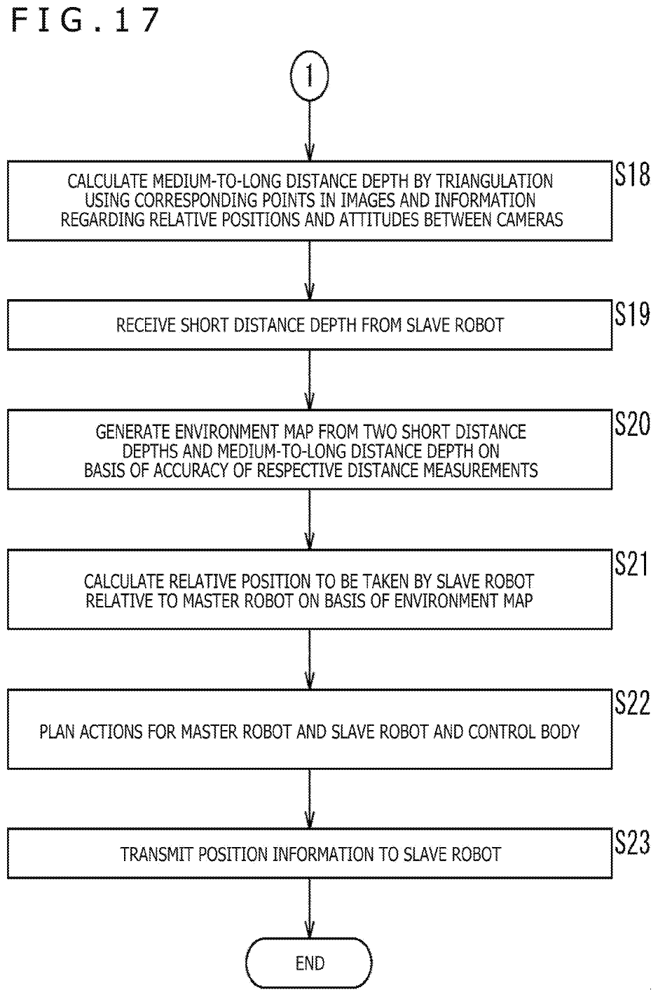

FIGS. 16 and 17 are flowcharts describing the control processing of the master robot 11.

In step S1, the side camera 31 transmits an image-capturing synchronization signal by which all the cameras capture respective images.

In step S12, the front camera 12L and the front camera 12R capture respective images and remove lens distortion from the images obtained by the image capturing. The images whose lens distortion has been removed are output to the single distance measurement section 33 and the image corresponding point detection section 34.

In step S13, the single distance measurement section 33 estimates disparity by stereo matching using the images supplied from the front camera 12L and the front camera 12R and calculates a short distance depth. The single distance measurement section 33 outputs the obtained short distance depth to the environment map generation section 36.

In step S14, the side camera 31 captures an image and removes lens distortion from the image obtained by the image capturing. The image whose lens distortion has been removed is output to the robot relative position estimation section 32.

In step S15, the robot relative position estimation section 32 estimates the position and attitude of the slave robot 21. Further, the robot relative position estimation section 32 calculates the position and attitude of the front camera 22 of the slave robot 21 and obtains information indicating the relative positions and attitudes between the cameras. The information indicating the relative positions and attitudes between the cameras is output to the medium-to-long distance depth estimation section 35.

In step S16, the environment map generation section 36 receives the image obtained by the image capturing using the front camera 22 (one side only) transmitted from the slave robot 21.

In step S17, the image corresponding point detection section 34 detects corresponding points in the images from the image obtained by the image capturing performed by the master robot 11 and the image obtained by the image capturing performed by the slave robot 21.

In step S18 of FIG. 17, the medium-to-long distance depth estimation section 35 calculates a medium-to-long distance depth by triangulation using the corresponding points in the images and information indicating the relative positions and attitudes between the cameras.

In step S19, the environment map generation section 36 receives a short distance depth from the slave robot 21.

In step S20, the environment map generation section 36 generates an environment map, which is the result of the cooperative distance measurement, from the two short distance depths and the medium-to-long distance depth on the basis of the accuracy of the respective distance measurements. The environment map is output to the relative position control section 37 and the action planning section 38.

In step S21, the relative position control section 37 calculates a relative position to be taken by the slave robot 21 relative to the master robot 11 on the basis of the environment map. The relative position control section 37 outputs information regarding the relative positions between the robots to the action planning section 38.

In step S22, the action planning section 38 plans actions for the master robot 11 and the slave robot 21. Correspondingly, the control section 39 controls the body of the master robot 11.

In step S23, the action planning section 38 transmits position information obtained by the action planning to the slave robot 21.

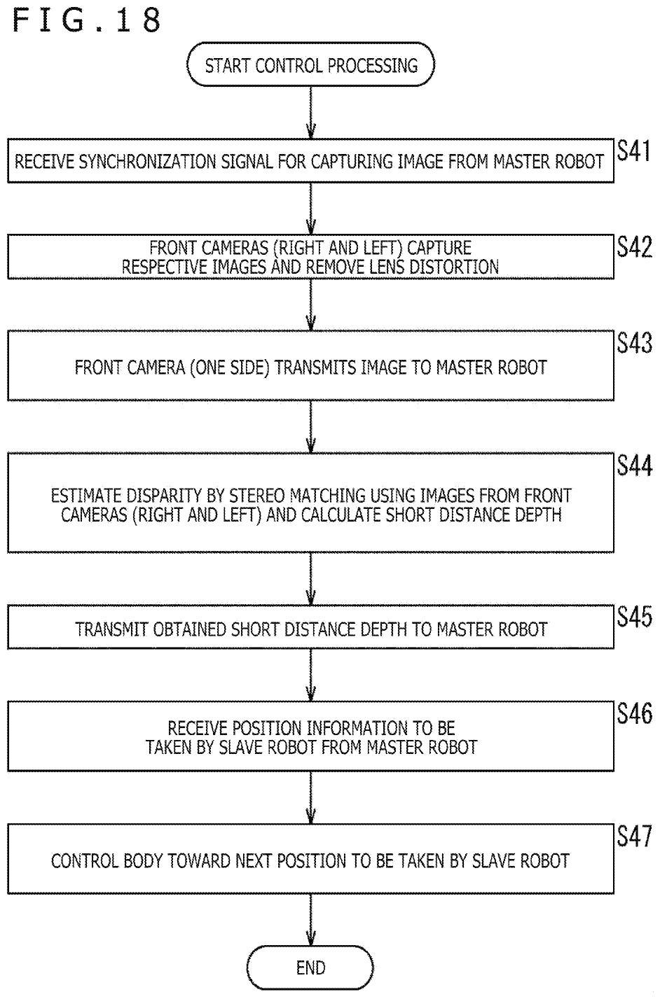

FIG. 18 is a flowchart describing control processing of the slave robot 21.

In step S41, the front cameras 22 receive the image-capturing synchronization signal transmitted from the master robot 11 in step S1 of FIG. 16.

In step S42, the front camera 22L and the front camera 22R capture respective images and remove lens distortion from the images obtained by the image capturing. The images whose lens distortion has been removed are output to the single distance measurement section 41.

In step S43, the front camera 22R transmits the image to the master robot 11.

In step S44, the single distance measurement section 41 estimates disparity by stereo matching using the images supplied from the front camera 22L and the front camera 12R and calculates a short distance depth.

In step S45, the single distance measurement section 41 transmits the obtained short distance depth to the master robot 11.

In step S46, the control section 42 receives the position information to be taken by the slave robot 21, which has been transmitted from the master robot 11 in step S23 of FIG. 17.

In step S47, the control section 42 controls the body toward the next position to be taken by the slave robot 21 on the basis of the received position information.

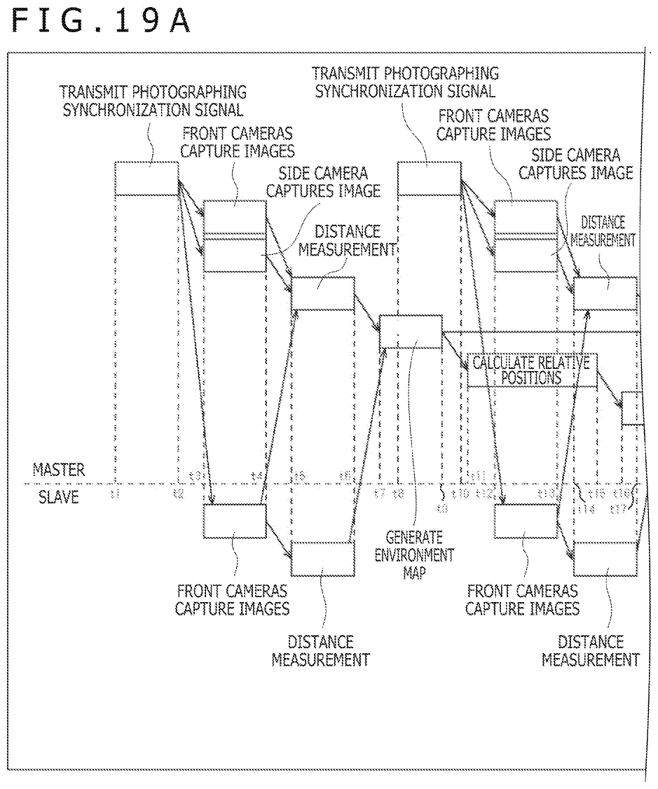

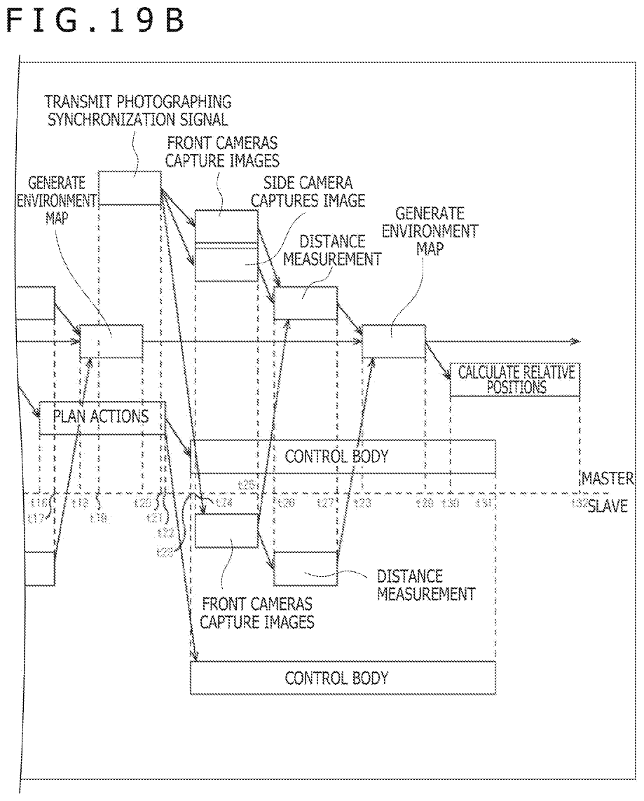

FIG. 19 is a diagram illustrating the timings of the control processing of the robots.

The upper side of a horizontal broken line represents the control in the master robot 11 while the lower side of the horizontal broken line represents the control in the slave robot 21.

The master robot 11 transmits an image-capturing synchronization signal from time t1 to time t2. From time t3 to time t4, the front cameras 12 and the side camera 31 of the master robot 11 and the front cameras 22 of the slave robot 21 capture respective images on the basis of the image-capturing synchronization signal.

From time t5 to time t6, the robot relative position estimation section 32, the single distance measurement section 33, the image corresponding point detection section 34, and the medium-to-long distance depth estimation section 35 of the master robot 11 and the single distance measurement section 41 of the slave robot 21 perform distance measurement.

At time t7, the environment map generation section 36 of the master robot 11 starts generating an environment map.

When the environment map generation has been completed at time t9, the relative position control section 37 performs relative position calculation processing on the basis of the generated environment map from time t11 to time t15. From time t16 to time t22, the action planning section 38 plans actions. From time t23 to time t31, the master robot 11 and the slave robot 21 control respective bodies.

Meanwhile, from time t8 to time t10 before the generation of the environment map generation has been completed, the master robot 11 transmits an image-capturing synchronization signal. From time t12 to time t13, the front cameras 12 and the side camera 31 of the master robot 11 and the front cameras 22 of the slave robot 21 capture respective images on the basis of the image-capturing synchronization signal.

From time t14 to time t17, the robot relative position estimation section 32, the single distance measurement section 33, the image corresponding point detection section 34, and the medium-to-long distance depth estimation section 35 of the master robot 11 and the single distance measurement section 41 of the slave robot 21 perform distance measurement.

From time t18 to time t20, the environment map generation section 36 of the master robot 11 generates an environment map. It is noted that the environment map generated at time t20 is not used for the relative position calculation. A newly generated environment map is always used for the relative position calculation.

Meanwhile, from time t19 to time t21 before the generation of the environment map generation has been completed, the master robot 11 transmits an image-capturing synchronization signal. From time t24 to time t25, the front cameras 12 and the side camera 31 of the master robot 11 and the front cameras 22 of the slave robot 21 capture respective images on the basis of the image-capturing synchronization signal.

From time t26 to time t27, the robot relative position estimation section 32, the single distance measurement section 33, the image corresponding point detection section 34, and the medium-to-long distance depth estimation section 35 of the master robot 11 and the single distance measurement section 41 of the slave robot 21 perform distance measurement.

At time t28, the environment map generation section 36 of the master robot 11 starts generating an environment map.

When the environment map generation has been completed at time t29, the relative position control section 37 performs the relative position calculation processing on the basis of the generated environment map from time t30 to time t32. At time t33 or later, action planning and body control are performed.

In this manner, the image-capturing cycle from the image capturing to the environment map generation is performed in a faster cycle than the action cycle from the relative position calculation to the action planning. It is noted that, since it takes time until the body is positioned at a desired position after the control signal is transmitted to the body, the action cycle does not need to be as fast as the image-capturing cycle. The action planning uses the latest environment map at that point in time.

In this manner, according to the present technology, the accuracy of the distance measurement for a long distance, which has been difficult only with the single distance measurement, is improved by cooperation. This makes it possible for the robots to move at high speed in a group, thereby improving the efficiency of package transportation and the like, for example.

Further, this makes it possible to avoid a moving object or recognize the three-dimensional shape of terrain and the like in real time.

### 2. Second Embodiment (High-Speed Package Delivery System)

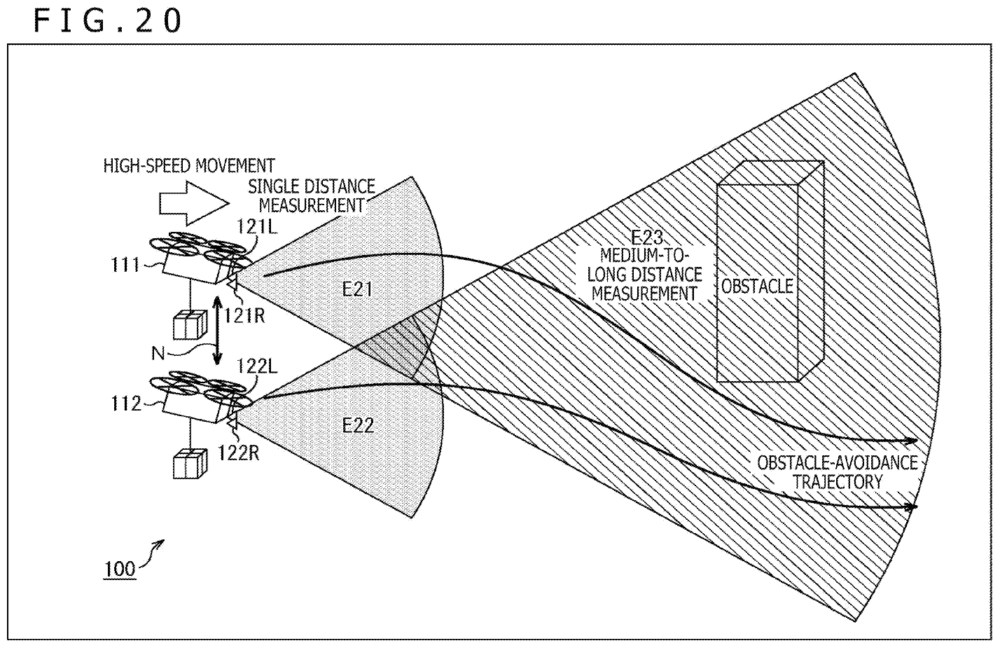

FIG. 20 is a diagram illustrating an example of a package delivery system to which the present technology is applied.

As illustrated in FIG. 20, a package delivery system 101 includes a robot 111 and a robot 112. In the case of FIG. 20, the robot 111 and the robot 112 are drones that deliver packages.

The robot 111 includes a front camera 121L and a front camera 121R. The robot 111 has a similar configuration to that of the robot 11 of FIG. 3. The robot 111 performs a single distance measurement targeting a short distance region E21 by using the front camera 121L and the front camera 121R.

The robot 112 includes a front camera 122L and a front camera 122R. The robot 112 has a similar configuration to that of the robot 21 of FIG. 3. The robot 112 performs a single distance measurement targeting a short distance region E22 by using the front camera 122L and the front camera 122R.

The package delivery system 101 performs a medium-to-long distance measurement by using the front camera 121L of the robot 111 and the front camera 122L of the robot 112 as a stereo camera. In this case, a long distance region E23, which is an overlapping region between the angle of view of the front camera 121L and the angle of view of the front camera 122L, is a region where the distance measurement can be performed.

As illustrated in FIG. 20, an arrow between the robot 111 and the robot 112 indicates a space N between the robot 111 and the robot 112. In the package delivery system 101, the size of the space N is controlled according to the movement speed, as described above with reference to FIG. 15.

In the package delivery system 101 with the configuration described above, the accuracy of the distance measurement for a long distance, which has been difficult with the single distance measurement, can be improved by cooperation. This enables the robots to move on an obstacle-avoidance trajectory where obstacles are avoided. Therefore, this enables the robots to move at high speed in a group and provide a high-speed package transportation service.

### 3. Third Embodiment (Terrain Observation System)

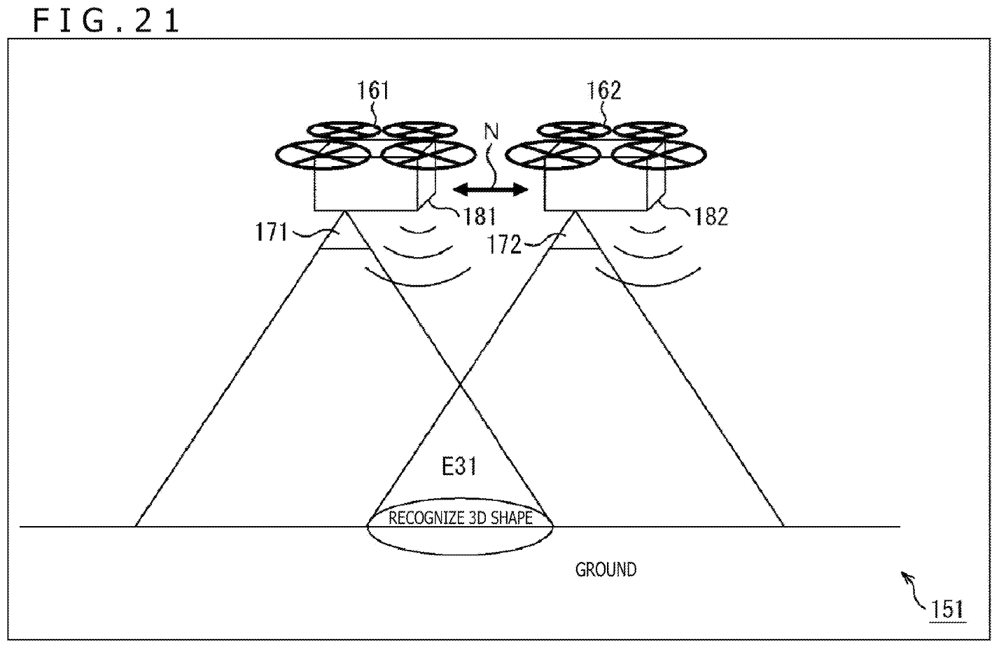

FIG. 21 is a diagram illustrating an example of a terrain observation system to which the present technology is applied.

As illustrated in FIG. 21, a terrain observation system 151 includes a robot 161 and a robot 162. In the case of FIG. 21, the robot 161 and the robot 162 are drones that observe terrain.

The robot 161 includes an image-capturing camera 171 and a sonar 181. The robot 162 includes an image-capturing camera 172 and a sonar 182.

Further, the terrain observation system 151 performs a medium-to-long distance measurement by using the image-capturing camera 171 of the robot 161 and the image-capturing camera 172 of the robot 162 as a stereo camera. In this case, a long distance region E31, which is an overlapping region between the angle of view of the image-capturing camera 171 and the angle of view of the image-capturing camera 172, is a region where the distance measurement can be performed. Therefore, a 3D shape located in the long distance region E31 can be recognized.

As illustrated in FIG. 21, an arrow between the robot 161 and the robot 162 indicates a space N between the robot 161 and the robot 162. The terrain observation system 151 controls the size of the space N according to the altitude obtained by GPS, as described above. In a case where the altitude is higher than a predetermined value, the space N between the robot 161 and the robot 162 is widened to the extent that the robot 161 and the robot 162 can recognize the relative positions each other. In a case where the altitude is lower than the predetermined value, the space N between the robot 161 and the robot 162 is narrowed. It is noted that, in a case of the altitude where the sensitivity of the sonars 181 and 182 can be reached, it is not possible to narrow the space any further.

In the terrain observation system 151 with the configuration described above, the distance measurement can be performed using the image-capturing cameras, and the 3D shape of the ground at a landing site can be recognized accurately.

It is noted that the present technology can be applied not only to the terrain observation system but also to a surveillance system and a security system.

### 4. Fourth Embodiment (Cart Delivery System)

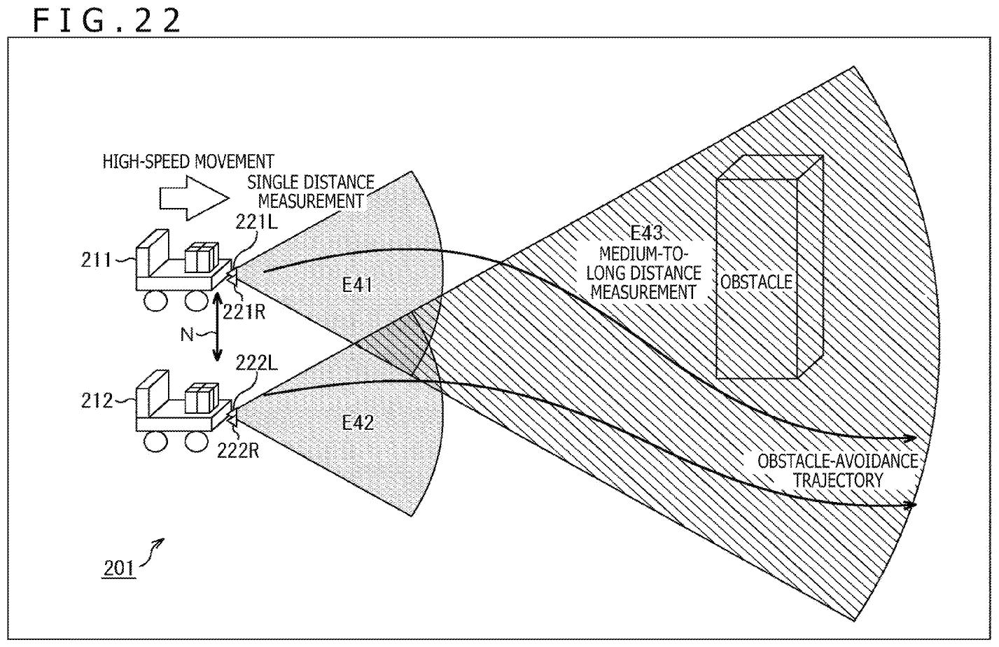

FIG. 22 is a diagram illustrating an example of a cart delivery system to which the present technology is applied.

As illustrated in FIG. 22, a cart delivery system 201 includes a robot 211 and a robot 212. In the case of FIG. 22, the robot 211 and the robot 212 include carts that deliver packages.

The robot 211 includes a front camera 221L and a front camera 221R. The robot 211 has a similar configuration to that of the robot 11 of FIG. 3. The robot 211 performs a single distance measurement targeting a short distance region E41 by using the front camera 221L and the front camera 121R.

The robot 212 includes a front camera 222L and a front camera 222R. The robot 212 has a similar configuration to that of the robot 21 of FIG. 3. The robot 212 performs a single distance measurement targeting a short distance region E42 by using the front camera 221L and the front camera 221R.

The cart delivery system 201 performs a medium-to-long distance measurement by using the front camera 221L of the robot 211 and the front camera 222L of the robot 221 as a stereo camera. In this case, a long distance region E43, which is an overlapping region between the angle of view of the front camera 221L and the angle of view of the front camera 222L, is a region where the distance measurement can be performed.

As illustrated in FIG. 22, an arrow between the robot 211 and the robot 212 indicates a space N between the robot 211 and the robot 212. In the cart delivery system 201, the size of the space N can be controlled according to the movement speed, as described above with reference to FIG. 15.

In the cart delivery system 201 with the configuration described above, the accuracy of the distance measurement for a long distance, which has been difficult only with the single distance measurement, can be improved by cooperation. This enables the robots to move on an obstacle-avoidance trajectory. Therefore, this enables the robots to move at high speed in a group and provide a high-speed package transportation service.

### 5. Fifth Embodiment (Distance Measurement Assistance System)

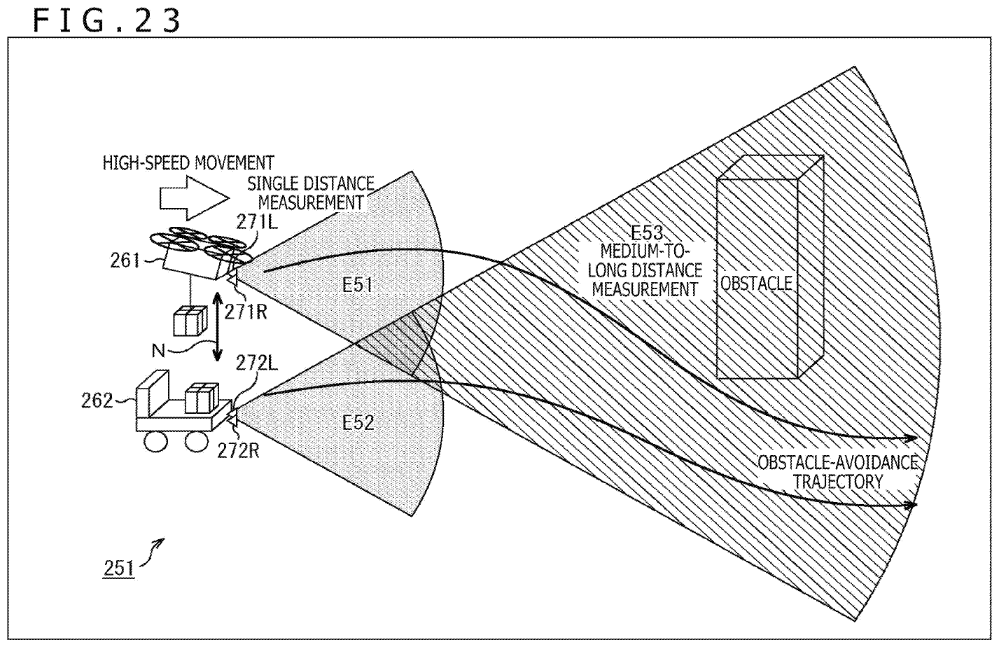

FIG. 23 is a diagram illustrating an example of a distance measurement assistance system to which the present technology is applied.

As illustrated in FIG. 23, a distance measurement assistance system 251 includes a robot 261 and a robot 262. The robot 261 is a drone that is a flying object for assisting a distance measurement and does not carry packages. The robot 262 includes a cart that transports packages.

The robot 261 includes a front camera 271L and a front camera 271R. The robot 261 has a similar configuration to that of the robot 11 of FIG. 3. The robot 261 performs a single distance measurement targeting a short distance region E51 by using the front camera 271L and a front camera 272R.

The robot 262 includes a front camera 272L and the front camera 272R. The robot 262 has a similar configuration to that of the robot 21 of FIG. 3. The robot 262 performs a single distance measurement targeting a short distance region E52 by using the front camera 271L and the front camera 271R.

The distance measurement assistance system 251 performs a medium-to-long distance measurement by using the front camera 271R of the robot 261 and the front camera 272L of the robot 261 as a stereo camera. In this case, a long distance region E53, which is an overlapping region between the angle of view of the front camera 271R and the angle of view of the front camera 271L, is a region where the distance measurement can be performed.

As illustrated in FIG. 23, an arrow between the robot 161 and the robot 162 indicates a space N between the robot 161 and the robot 162. In the distance measurement assistance system 251, the size of the space N can be controlled according to the movement speed, as described above with reference to FIG. 15.

In the distance measurement assistance system 251 with the configuration described above, the accuracy of the distance measurement for a long distance, which has been difficult only with the single distance measurement, can be improved by cooperation. This enables the robots to move on an obstacle-avoidance trajectory. Therefore, this enables the robots to move at high speed in a group and provide a high-speed package transportation service.

### 6. Sixth Embodiment (Robot Control System with Three Robots)

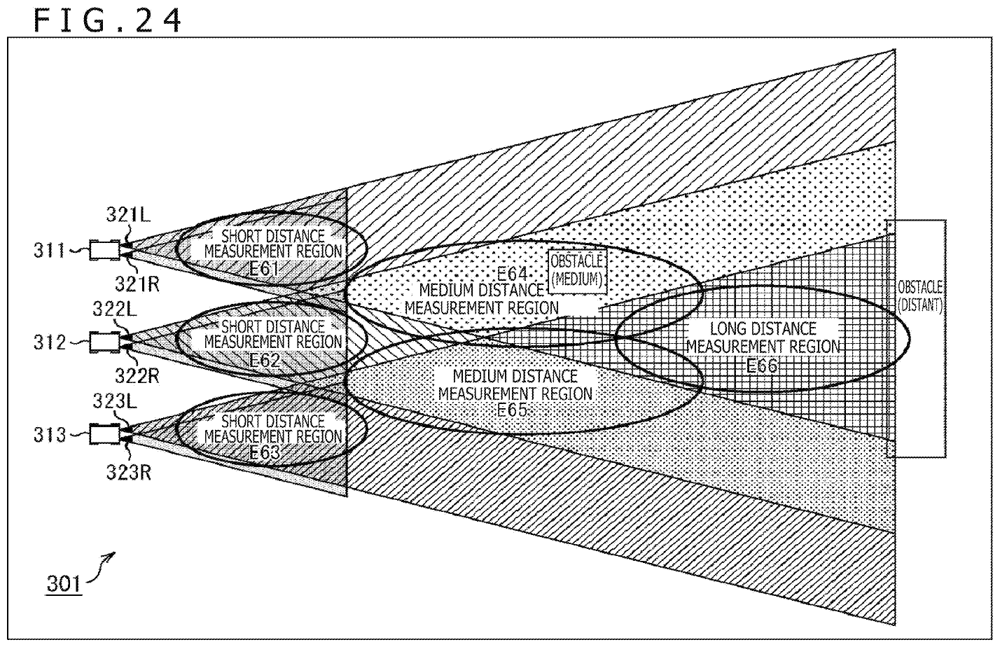

FIG. 24 is a diagram illustrating an example of a robot control system with three robots to which the present technology is applied.

As illustrated in FIG. 24, a robot control system 301 includes robots 311 to 313. In the case of FIG. 24, the robots 311 to 313 include drones, carts, vehicles, or the like.

The robot 311 includes a front camera 321L and a front camera 321R. The robot 311 has a similar configuration to that of the robot 11 of FIG. 3. The robot 311 performs a single distance measurement targeting a short distance region E61 by using the front camera 321L and the front camera 321R.

The robot 312 includes a front camera 322L and a front camera 322R. The robot 312 has a similar configuration to that of the robot 21 of FIG. 3. The robot 312 performs a single distance measurement targeting a short distance region E62 by using the front camera 322L and the front camera 322R.

The robot 313 includes a front camera 323L and a front camera 323R. The robot 313 has a similar configuration to that of the robot 21 of FIG. 3. The robot 313 performs a single distance measurement targeting a short distance region E63 by using the front camera 323L and the front camera 323R.

The robot control system 301 performs a medium distance measurement by using the front camera 321L of the robot 311 and the front camera 322L of the robot 312 as a stereo camera. In this case, a medium distance region E64, which is an overlapping region between the angle of view of the front camera 321L and the angle of view of the front camera 321L, is a region where the distance measurement can be performed.

The robot control system 301 performs a medium distance measurement by using the front camera 322L of the robot 312 and the front camera 323L of the robot 313 as a stereo camera. In this case, a medium distance region E65, which is an overlapping region between the angle of view of the front camera 322L and the angle of view of the front camera 323L, is a region where the distance measurement can be performed.

The robot control system 301 performs a long distance measurement by using the front camera 321L of the robot 311, the front camera 322L of the robot 312, and the front camera 323L of the robot 313 as a stereo camera. In this case, a long distance region E66, which is an overlapping region between the front camera 321L of the robot 311, the angle of view of the front camera 322L, and the angle of view of the front camera 323L, is a region where the distance measurement can be performed.

In the robot control system 301 with the configuration described above, the accuracy of the distance measurement for a long distance, which has been difficult only with the single distance measurement, can be improved by cooperation. This enables the robots to move on an obstacle-avoidance trajectory. Therefore, this enables the robots to move at high speed in a group and provide a high-speed package transportation service.

### 7. Seventh Embodiment (Robot Control System with Plurality of Robots)

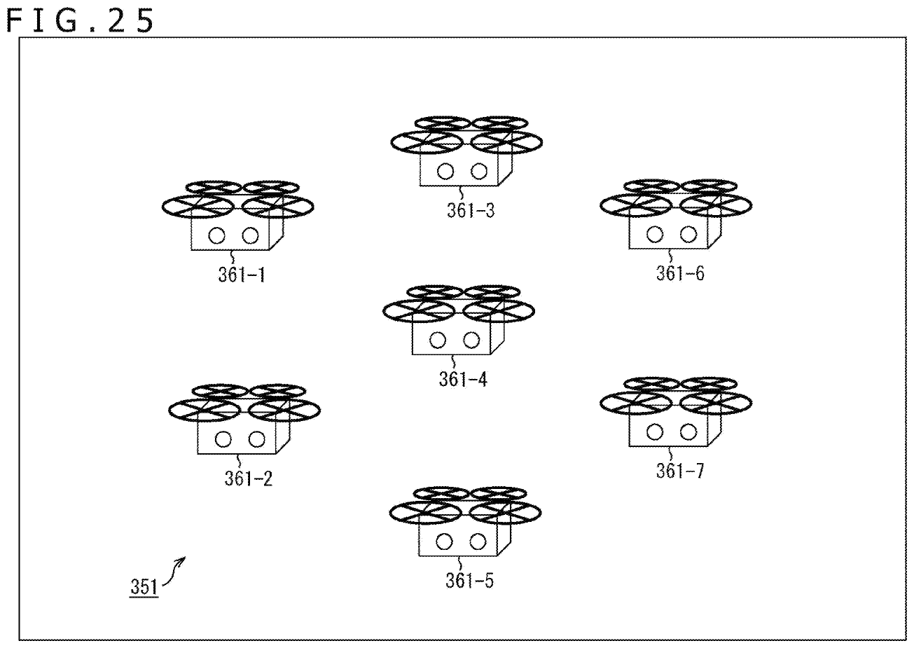

FIG. 25 is a diagram illustrating an example of a robot control system with a plurality of robots to which the present technology is applied.

As illustrated in FIG. 25, a robot control system 351 includes robots 361 to 363. In the case of FIG. 24, the robots 361-1 to 361-7 include drones, carts, vehicles, or the like.

Each of the robots 361-1 to 361-7 includes front cameras. Each of the robots 361-1 to 361-7 has a similar configuration to that of the robot 11 of FIG. 3.

By forming an array, the robots 361-1 to 361-7 can be regarded as a large multi-lens camera (Light field camera), thereby reducing matching errors when obtaining corresponding points between images.

The radius of a circle including the robots 361-1 to 361-7 (the space between each robot) corresponds to the baseline length described above. Thus, the radius can be controlled according to the obstacles' distance distribution and the speed.

In the robot control system 351 with the configuration described above, the accuracy of the distance measurement for a long distance, which has been difficult only with the single distance measurement, can be improved by cooperation.

It is noted that, under the user's instruction, the control section 39 may set the group including the plurality of robots that performs the cooperative distance measurement, for example.

### 8. Computer

<Example of Hardware Configuration of Computer>

The series of processes described above can be performed by hardware or software. In a case where the series of processes is performed by software, a program constituting the software is installed in a computer. Here, the computer includes a computer incorporated in dedicated hardware, a general-purpose personal computer, for example, capable of executing various kinds of functions with various kinds of programs installed therein, and the like.

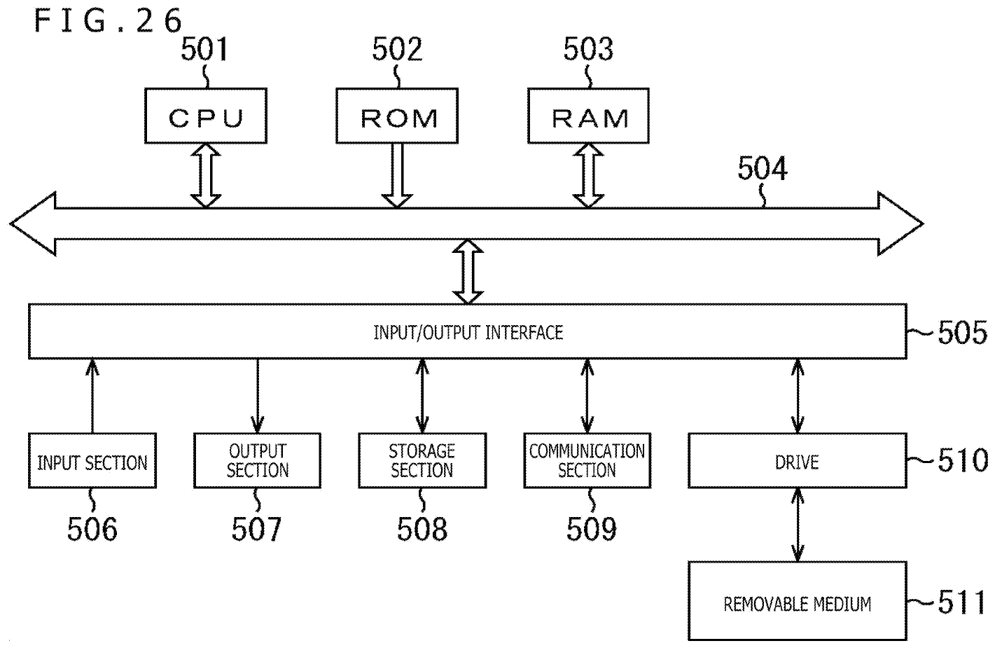

FIG. 26 is a block diagram illustrating an example of a hardware configuration of a computer that performs the above-described series of processes using a program.

In the computer, a CPU (Central Processing Unit) 501, a ROM (Read Only Memory) 502, and a RAM (Random Access Memory) 503 are connected to each other via a bus 504.

Moreover, an input/output interface 505 is also connected to the bus 504. An input section 506, an output section 507, a storage section 508, a communication section 509, and a drive 510 are connected to the input/output interface 505.

The input section 506 includes a keyboard, a mouse, a microphone, and the like. The output section 507 includes a display, a speaker, and the like. The storage section 508 includes a hard disk, a nonvolatile memory, and the like. The communication section 509 includes a network interface and the like. The drive 510 drives a removable medium 511 such as a magnetic disk, an optical disc, a magneto-optical disk, or a semiconductor memory.

In the computer configured as above, the CPU 501 performs the above-described series of processes by loading the program, which is stored in the storage section 508, into the RAM 503 via the input/output interface 505 and the bus 504 and executing the program, for example.

The program to be executed by the computer (CPU 501) can be recorded on the removable medium 511 as a package medium or the like and provided, for example. Further, this program can be provided via a wired or wireless transmission medium such as a local area network, the Internet, or digital satellite broadcasting.

In the computer, the removable medium 511 is attached to the drive 510 so that the program can be installed in the storage section 508 via the input/output interface 505. Further, the program can also be received by the communication section 509 and installed in the storage section 508 via a wired or wireless transmission medium. Alternatively, this program can be installed in the ROM 502 or the storage section 508 in advance.

It is noted that the program to be executed by the computer may be a program that performs processes in chronological order in the order described in the present specification or a program that performs processes in parallel or at necessary timings on occasions of calls or the like.

Further, in the present specification, a system refers to a collection of a plurality of constituent elements (apparatuses, modules (components), and the like), and it does not matter whether or not all the constituent elements are within the same housing. Therefore, a plurality of apparatuses stored in separate housings and connected via a network, and one apparatus storing a plurality of modules in one housing are, in either case, the system.

It is noted that the effects described in the present specification are merely examples and are not limited. Further, there may be additional effects.

The embodiments of the present technology are not limited to the above-described embodiments, and various modifications can be made without departing from the scope of the present technology.

For example, the present technology can be configured as cloud computing in which one function is shared and processed collaboratively among a plurality of apparatuses via a network.

Further, each step described in the above-described flowcharts can be performed by a single apparatus or can be shared and performed by a plurality of apparatuses.

Moreover, in a case where one step includes a plurality of processes, the plurality of processes included in this one step can be performed not only by one apparatus but also by a plurality of apparatuses in a shared manner.

[Example of Combination of Configurations]

The present technology can also have the following configurations.

(1)

A mobile object including:

a cooperative sensing section configured to obtain sensing information by performing sensing in cooperation with another mobile object; and

a control section configured to control movement according to a cooperative distance measurement using the sensing information, the cooperative distance measurement being a distance measurement performed in cooperation with the another mobile object.

(2)

The mobile object according to (1),

in which the sensing information includes distance information based on image information and cooperative distance information based on the image information obtained from each of at least two of the mobile objects, and

the control section controls the movement on the basis of the distance information and the cooperative distance information.

(3)

The mobile object according to (2),

in which the sensing information includes the sensing information of the another mobile object and the sensing information of the mobile object itself, and

the control section controls the movement on the basis of the sensing information of the another mobile object and the sensing information of the mobile object itself.

(4)

The mobile object according to (2) or (3), in which the cooperative sensing section obtains the image information by capturing an image in synchronization with the another mobile object.

(5)

The mobile object according to any one of (2) to (4), in which the cooperative sensing section calculates the distance information.

(6)

The mobile object according to any one of (2) to (5), in which the cooperative sensing section calculates the cooperative distance information.

(7)

The mobile object according to any one of (1) to (6), in which the control section controls the movement according to a position obtained from the cooperative distance measurement.

(8)

The mobile object according to any one of (1) to (7), in which the control section controls the movement according to a distance to the another mobile object obtained from the cooperative distance measurement.

(9)

The mobile object according to any one of (1) to (8), further including:

a group setting section configured to set a group including the another mobile object,

in which the cooperative sensing section performs the sensing in cooperation with the another mobile object included in the group that has been set.

(10)

The mobile object according to any one of (1) to (9), further including:

a transmission section configured to transmit information obtained from the cooperative distance measurement to the another mobile object.

(11)

The mobile object according to any one of (1) to (10), further including:

a cooperative distance measurement section configured to perform the cooperative distance measurement.

(12)

A method for controlling a mobile object, the method including:

obtaining sensing information by performing sensing in cooperation with another mobile object; and

controlling movement according to a cooperative distance measurement using the sensing information, the cooperative distance measurement being a distance measurement performed in cooperation with the another mobile object.

### REFERENCE SIGNS LIST

1 Robot control system, 11 Robot, 12L, 12R Front camera, 21 Robot, 22L, 22R Front camera, 31 Side camera, 32 Robot relative position estimation section, 33 Single distance measurement section, 34 Image corresponding point detection section, 35 Medium-to-long distance depth estimation section, 36 Environment map generation section, 37 Relative position control section, 38 Action planning section, 39 Control section, 41 Single distance measurement section, 42 Control section, 61 Observation camera, 101 Package delivery system, 111, 112 Robot, 121L, 121R Front camera, 122L, 122R Front camera, 151 Terrain observation system, 161, 162 Robot, 171, 172 Image-capturing camera, 181, 182 Sonar, 201 Cart delivery system, 211, 212 Robot, 221L, 221R Front camera, 222L, 222R Front camera, 251 Distance measurement assistance system, 261, 262 Robot, 271L, 271R Front camera, 272L, 272R Front camera, 301 Robot control system, 311 to 313 Robot, 321L, 321R Front camera, 322L, 322R Front camera, 323L, 323R Front camera, 351 Robot control system, 361-1 to 361-7 Robot

1. A mobile object comprising:
a cooperative sensing section configured to obtain sensing information by performing sensing in cooperation with another mobile object; and
a control section configured to control movement according to a cooperative distance measurement using the sensing information, the cooperative distance measurement being a distance measurement performed in cooperation with the another mobile object.

2. The mobile object according to claim 1,
wherein the sensing information includes distance information based on image information and cooperative distance information based on the image information obtained from each of at least two of the mobile objects, and
the control section controls the movement on a basis of the distance information and the cooperative distance information.

3. The mobile object according to claim 2,
wherein the sensing information includes the sensing information of the another mobile object and the sensing information of the mobile object itself, and
the control section controls the movement on a basis of the sensing information of the another mobile object and the sensing information of the mobile object itself.

4. The mobile object according to claim 2, wherein the cooperative sensing section obtains the image information by capturing an image in synchronization with the another mobile object.

5. The mobile object according to claim 2, wherein the cooperative sensing section calculates the distance information.

6. The mobile object according to claim 2, wherein the cooperative sensing section calculates the cooperative distance information.

7. The mobile object according to claim 1, wherein the control section controls the movement according to a position obtained from the cooperative distance measurement.

8. The mobile object according to claim 1, wherein the control section controls the movement according to a distance to the another mobile object obtained from the cooperative distance measurement.

9. The mobile object according to claim 1, further comprising:
a group setting section configured to set a group including the another mobile object,
wherein the cooperative sensing section performs the sensing in cooperation with the another mobile object included in the group that has been set.

10. The mobile object according to claim 1, further comprising:
a transmission section configured to transmit information obtained from the cooperative distance measurement to the another mobile object.

11. The mobile object according to claim 1, further comprising:
a cooperative distance measurement section configured to perform the cooperative distance measurement.

12. A method for controlling a mobile object, the method comprising:
obtaining sensing information by performing sensing in cooperation with another mobile object; and
controlling movement according to a cooperative distance measurement using the sensing information, the cooperative distance measurement being a distance measurement performed in cooperation with the another mobile object.
